(19) United States
(12) Patent Application Publication
(10) Pub. No.: US 2025/0357983 A1
(43) Pub. Date: Nov. 20, 2025

(54) CONFIGURING CSI RESOURCES FOR INTER-DU L1/L2 MOBILITY CANDIDATES

(71) Applicant: TELEFONAKTIEBOLAGET LM ERICSSON (PUBL), Stockholm (SE)

(72) Inventors: Icaro Leonardo Da Silva, SOLNA (SE); Claes Tidestav, BÅLSTA (SE)

(21) Appl. No.: 18/872,864

(22) PCT Filed: Jun. 28, 2023
(86) PCT No.: PCT/IB2023/056709

§ 371 Date: Dec. 9, 2024

Related U.S. Application Data
(60) Provisional application No. 63/356,461, filed on Jun. 28, 2022.

(51) Int. Cl. H04B 7/06; H04W 24/10; H04W 74/0833

(52) U.S. Cl. CPC H04B 7/0626; H04W 24/10; H04W 74/0833

(57) ABSTRACT

Embodiments include methods for a user equipment (UE) configured to communicate with a radio access network (RAN) node comprising a central unit (CU) and a distributed unit (DU) via a serving cell. Such methods include receiving, from the CU via the DU, an RRCReconfiguration message that includes channel state information (CSI) resource configurations associated with at least one candidate cell for L1/L2-based inter-cell mobility. The at least one candidate cell is provided by one or more neighbor DUs. Such methods include performing CSI measurements on the at least one candidate cell according to the respective CSI resource configurations and sending, to the DU via the serving cell, one or more CSI reports based on the CSI measurements performed. Other embodiments include complementary methods for a CU, a first DU, and a second DU, as well as UEs, CUs, and DUs configured to perform such methods.

### TECHNICAL FIELD

The present application relates generally to the field of wireless networks, and more specifically to improving mobility of user equipment (UEs) across multiple cells in a wireless network, specifically to cells provided by different distributed units (DUs) that may be associated with a single centralized unit (CU).

### INTRODUCTION

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. As such, each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows an exemplary configuration of NR user plane (UP) and control plane (CP) protocol stacks between a UE (210), a gNB (220), and an AMF (230). The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB.

Long-Term Evolution (LTE) Rel-10 introduced support for channel bandwidths larger than 20 MHz, which continues into NR. To remain compatible with legacy UEs from earlier releases (e.g., Rel-8), a wideband LTE Rel-10 carrier appears as multiple component carriers (CCs), each having the structure of an Rel-8 carrier. The Rel-10 UE can receive multiple CCs based on Carrier Aggregation (CA). The CCs can also be considered “cells”, such that a UE in CA has one primary cell (PCell) and one or more secondary cells (SCells). These are referred to collectively as a “cell group”. NR also supports CA starting in Rel-15.

In addition to providing coverage via cells as in LTE, NR networks also provide coverage via “beams”, which are network-transmitted reference signals (RS) that may be measured or monitored by a UE. To support beam management, a UE can be configured with a Channel State Information (CSI) measurement configuration, which instructs the UE to monitor CSI-RS and to send various CSI reports to the RAN (e.g., NG-RAN). For example, the RAN indicates an explicit list of CSI resources to be monitored by the UE for each type of CSI report the UE is configured to send. Similar techniques can be used for beam management based on synchronization signal/PBCH block (SSB) RS transmitted by the network.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell change via L1/L2 signaling to address these problems and/or difficulties.

### SUMMARY

These Rel-18 L1/L2 mobility enhancements also must consider the split CU/DU architecture shown in FIG. 1 and discussed above, including for intra-DU and inter-DU/intra-CU cell changes in which the UE's source and target cells are served by different source and target DUs associated with a single CU. However, there are various problems, issues, and/or difficulties.

For example, it is desirable that L1/L2 cell changes behave like intra-cell beam management, except that a UE is configured to perform measurements on a cell other than its serving cell. Currently, however, beam management configurations that support this capability are generated by a DU based only on the cells that it provides. As such, there is no capability to configure CSI-RS (or SSB) resources in L1/L2 mobility candidate cells provided by neighbor DUs, i.e., for inter-DU cell changes.

An object of embodiments of the present disclosure is to address these and related problems, issues, and/or difficulties, thereby facilitating UE L1/L2 mobility between cells in a RAN (e.g., NG-RAN).

Some embodiments of the present disclosure include methods (e.g., procedures) for a UE configured to communicate with a RAN node comprising a CU and a DU.

These exemplary methods can include receiving, from the CU via the DU, an RRCReconfiguration message that includes channel state information (CSI) resource configurations associated with each of at least one candidate cell for L1/L2-based inter-cell mobility. The at least one candidate cell is provided by one or more neighbor DUs. In some embodiments, the one or more neighbor DUs are associated with the CU and/or are part of the RAN node. These exemplary methods also include performing CSI measurements on the at least one candidate cell according to the respective CSI resource configurations and sending, to the DU via the serving cell, one or more CSI reports based on the CSI measurements performed on the at least one candidate cell.

In some embodiments, the RRCReconfiguration message also includes configurations associated with the at least one candidate cells. In some of these embodiments, the exemplary method can also include receiving from the DU a lower layer signalling message indicating that the UE should change its serving cell to a first candidate cell identified in the RRCReconfiguration message, and performing an L1/L2 mobility procedure towards the first candidate cell and communicating in the first candidate cell according to the configuration associated with the first candidate cell.

Other embodiments include methods (e.g., procedures) for a CU of a RAN node. In general, these exemplary methods are complementary to the exemplary methods for a UE summarized above.

These exemplary methods include sending, to a second DU of the RAN node, a request to configure a UE for L1/L2-based inter-cell mobility from a serving cell provided by a first DU of the RAN node to at least one candidate cell provided by the second DU. These exemplary methods include receiving, from the second DU, a response including CSI resource configurations associated with the at least one candidate cell provided by the second DU. These exemplary methods include sending, to the first DU for transmission to the UE vis the serving cell, an RRCReconfiguration message that includes CSI resource configurations associated with the at least one candidate cell provided by the second DU.

In some embodiments, the response also includes configurations associated with each of the at least one candidate cells and the RRCReconfiguration message also includes the configurations associated with each of the at least one candidate cells.

In some embodiments, the second DU is a neighbor DU that does not provide the UE's serving cell; the request to configure the UE is, or is included in, a UE CONTEXT SETUP REQUEST message; and the response is, or is included in, a UE CONTEXT SETUP RESPONSE message.

Other embodiments include methods (e.g., procedures) for a first DU of a RAN node. In general, these exemplary methods are complementary to the exemplary methods for a UE and for a CU, summarized above.

These exemplary methods include receiving, from a CU of the RAN node, a request to configure a UE with a reporting configuration for a serving cell provided by the first DU, in association with configuring L1/L2-based inter-cell mobility for the UE. These exemplary methods include sending, to the CU, a response including a reporting configuration that identifies a physical channel of the serving cell to be used for sending CSI reports pertaining to candidate cells for L1/L2-based inter-cell mobility.

In some embodiments, the reporting configuration includes one or more of the following:
configuration of physical channels used for sending CSI reports;
indication of one or more quantities or metrics to be reported; and
one or more conditions that trigger sending CSI reports.

In some embodiments, the response also includes CSI resource configurations associated with at least one candidate cell for L1/L2-based inter-cell mobility, with the at least one candidate cell being provided by the first DU.

Other embodiments include methods (e.g., procedures) for a second DU of a RAN node. In general, these exemplary methods are complementary to the exemplary methods for a UE, for a CU, and for a first DU, summarized above.

These exemplary methods include receiving, from a CU of the RAN node, a request to configure a UE for L1/L2-based inter-cell mobility from a serving cell provided by a first DU of the RAN node to at least one candidate cell provided by the second DU. These exemplary methods include sending, to the CU, a response including CSI resource configurations associated with the at least one candidate cell L1/L2-based inter-cell mobility.

In some embodiments, the response also includes configurations associated with each of the at least one candidate cells and these exemplary methods also include performing an L1/L2 mobility procedure with the UE in a first one of the candidate cells and communicating with the UE in the first candidate cell according to the configuration associated with the first candidate cell.

Other embodiments include UEs, CUs, and DUs configured to perform operations corresponding to any of the exemplary methods described herein. Other embodiments also include non-transitory, computer-readable media storing computer-executable instructions that, when executed by processing circuitry, configure such UEs, CUs, and DUs to perform operations corresponding to any of the exemplary methods described herein.

These and other embodiments can facilitate configuring a UE with CSI measurement resources for one or more L1/L2 inter-cell mobility candidate cells associated with a neighbor DU, on which the UE can perform and report mobility measurements to the network. These CSI reports facilitate L1/L2 inter-cell mobility decisions by the network, which enables the UE to move around in the network's coverage area. This promotes more efficient signaling, reduced processing, and reduced interruption time compared to a L3 (e.g., RRC) handover. Embodiments also maintain L1/L2 mobility interoperability between the UE, the serving DU/CU, and the neighbor DU without ambiguities.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 show logical architectures for a gNB arranged in the split CU/DU architecture illustrated by FIG. 1.

FIG. 5 shows an exemplary ASN.1 data structure for an RRC CSI-MeasConfig information element (IE) used to configure CSI-RS resources for UE monitoring.

FIG. 6 shows an exemplary ASN.1 data structure of an RRC CSI-SSB-ResourceSet IE.

FIGS. 7-8 show signaling diagrams of procedures between a UE, a serving DU, a candidate DU, and a CU, according to various embodiments of the present disclosure.

FIGS. 9-15 show exemplary ASN.1 data structures that can be used for CSI resource configuration, according to various embodiments of the present disclosure.

FIG. 16A-B shows a signaling diagrams of a procedure between a UE, a serving DU, a neighbor DU, and a CU, according to various embodiments of the present disclosure.

FIG. 17 shows a signaling diagrams of a procedure between a UE, a serving DU, and a CU, according to various embodiments of the present disclosure.

FIG. 18A-B shows a signaling diagrams of a procedure between a UE, a serving DU, two neighbor DUs, and a CU, according to various embodiments of the present disclosure.

FIG. 19 shows an exemplary method (e.g., procedure) for a UE, according to various embodiments of the present disclosure.

FIG. 20 shows an exemplary method (e.g., procedure) for a CU, according to various embodiments of the present disclosure.

FIG. 21 shows an exemplary method (e.g., procedure) for a first DU, according to various embodiments of the present disclosure.

FIG. 22 shows an exemplary method (e.g., procedure) for a second DU, according to various embodiments of the present disclosure.

FIG. 23 shows a communication system according to various embodiments of the present disclosure.

FIG. 24 shows a UE according to various embodiments of the present disclosure.

FIG. 25 shows a network node according to various embodiments of the present disclosure.

FIG. 26 shows host computing system according to various embodiments of the present disclosure.

FIG. 27 is a block diagram of a virtualization environment in which functions implemented by some embodiments of the present disclosure may be virtualized.

FIG. 28 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term. “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

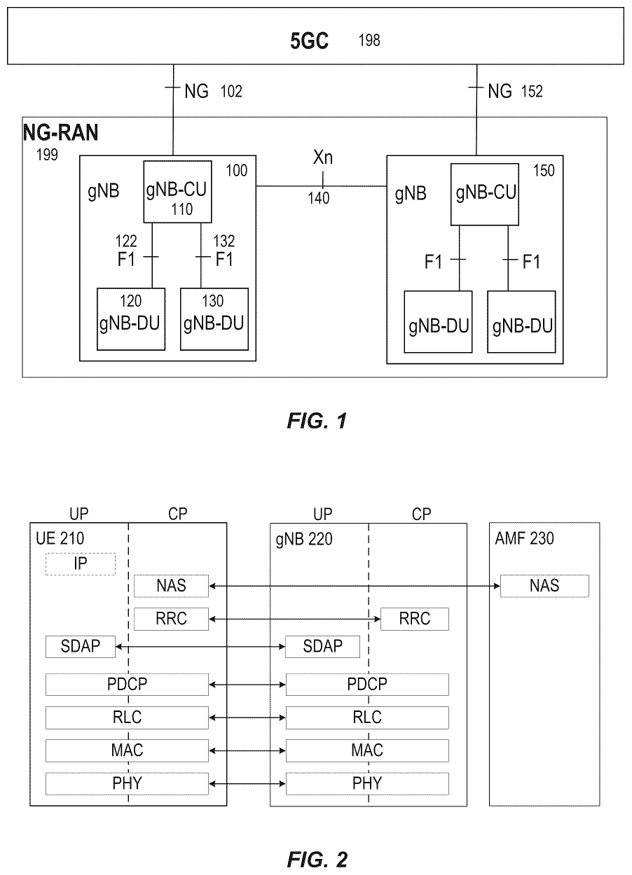

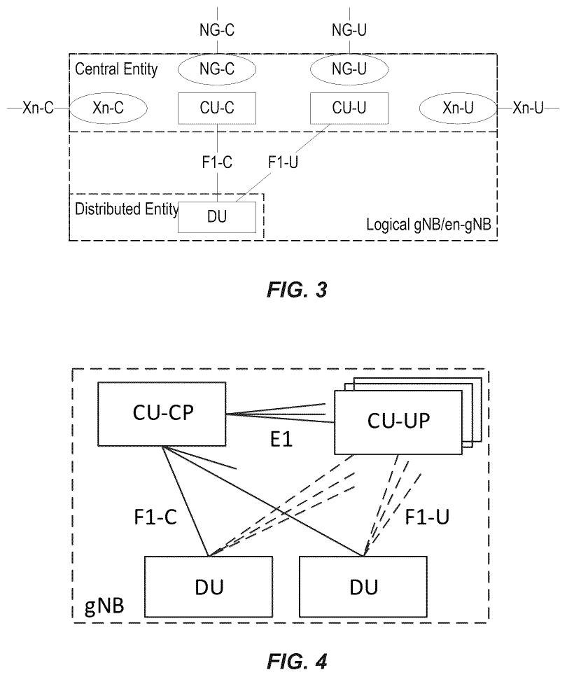

FIG. 3 shows a logical architecture for a gNB arranged in the split CU/DU architecture, such as gNB 100 in FIG. 1. This logical architecture separates the CU into CP and UP functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP. Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

As briefly mentioned above, to support beam management, a UE can be configured with a Channel State Information (CSI) measurement configuration, which instructs the UE to monitor CSI-RS and to send various CSI reports to the NG-RAN. For example, the NG-RAN indicates an explicit list of CSI resources to be monitored by the UE for each type of CSI report the UE is configured to send. In the split-gNB architecture, the UE is configured by and sends the CSI reports to the DU that provides the UE's serving cell. Similar techniques can be used for beam management based on SSB transmitted by the DU in the serving cell.

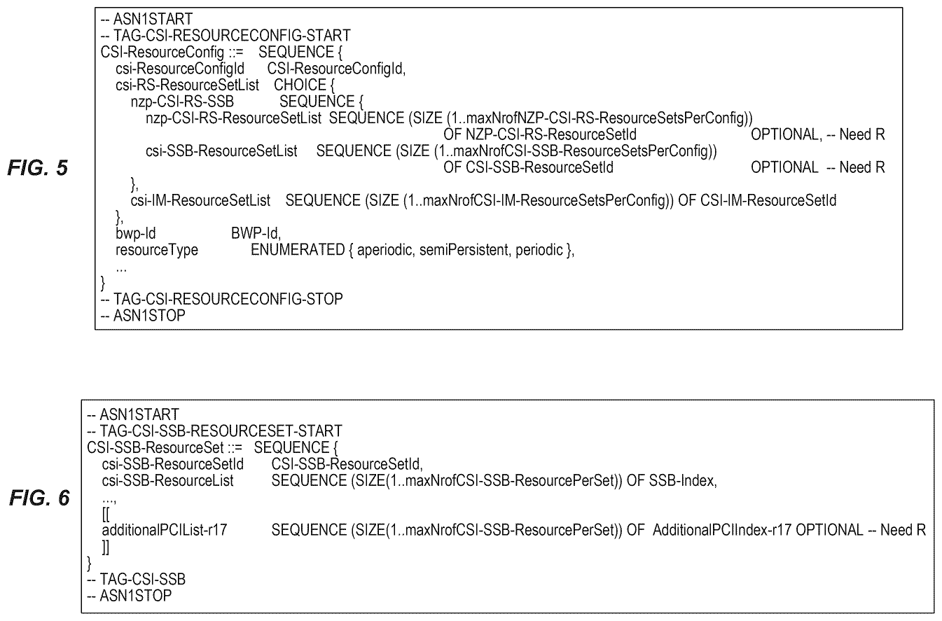

FIG. 5 shows an exemplary ASN.1 data structure for an RRC CSI-MeasConfig information element (IE) used to configure CSI-RS resources for UE monitoring. This IE is configured per UE serving cell, within a ServingCellConfig IE, which associates serving cell and corresponding CSI reports. For each type of CSI report the UE needs to transmit, the network indicates an explicit list of CSI resources in the nzp-CSI-RS-ResourceSetList IE shown in FIG. 5. The network can provide a list of up to maxNrofNZP-CSI-RS-ResourceSetsPerConfig CSI resource sets for each of the UE's serving cells, including PCell/SpCell and any configured SCells. Table 1 below further defines certain fields included in the data structure shown in FIG. 5.

TABLE 1

| Field name | Description |
|---|---|
| bwp-Id | The DL BWP which the CSI-RS associated with this CSI- |
| | ResourceConfig are located in. |
| csi-IM-ResourceSetList | List of references to CSI-IM resources used for CSI |
| | measurement and reporting in a CSI-RS resource set. Contains |
| | up to maxNrofCSI-IM-ResourceSetsPerConfig resource sets if |
| | resourceType is ‘aperiodic’ and 1 otherwise. |
| csi-ResourceConfigId | Used in CSI-ReportConfig to refer to an instance of CSI- |
| | ResourceConfig. |
| csi-SSB-ResourceSetList | List of references to SSB resources used for CSI measurement |
| | and reporting in a CSI-RS resource set. |
| nzp-CSI-RS-ResourceSetList | List of references to NZP CSI-RS resources used for beam |
| | measurement and reporting in a CSI-RS resource set. Contains |
| | up to maxNrofNZP-CSI-RS-ResourceSetsPerConfig resource |
| | sets if resourceType is ‘aperiodic’ and 1 otherwise. |
| resourceType | Time domain behavior of resource configuration. It does not |
| | apply to resources provided in the csi-SSB-ResourceSetList. |

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a high-level goal of the Rel-18 L1/L2 mobility enhancements is to facilitate serving cell change via L1/L2 signaling to address these problems and/or difficulties. Some more specific goals include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also must take into account the split CU/DU architecture shown in FIGS. 1 and 3-4, including for intra-DU and inter-DU/intra-CU cell changes. In the inter-DU/intra-CU scenario, the candidate cell for L1/L2 inter-cell mobility is a cell served by a neighbor DU to the (serving or source) DU that currently provides the UE's PCell (or PSCell, for SCG change in DC).

As briefly mentioned above, it is desirable that L1/L2 cell changes behave like intra-cell beam management, except that a UE is configured to perform measurements on a cell other than its serving cell. There are various problems, difficulties, and/or issues that prevent and/or inhibit this desirable outcome.

The Rel-15 solution for configuring UE measurements to support beam management is limited to configuring only CSI-RS (or SSB) resources in the UE's current serving cells (e.g., PCell and SCells) of the cell group (e.g., MCG) associated with the configuration. This solution does not support configuring a UE with CSI-RS resources to be measured in a L1/L2 inter-cell mobility candidate cell that is not one of the UE's current serving cells (even if on the same frequency).

3GPP Rel-17 includes support for inter-physical cell identity (PCI) multi-transmission reception point (mTRP) operation. In this feature, a CSI resource may be associated with a PCI that is different than PCIs associates with a UE's serving cells. The UE receives an explicit indication of which beams (SSBs) and PCIs to measure for a given reporting configuration. FIG. 6 shows an exemplary ASN.1 data structure of an RRC CSI-SSB-ResourceSet IE by which this feature can be configured. In particular, the additionalPCIList-r17 field indicates PCIs of the SSBs in the csi-SSB-ResourceList field in the IE. If present, the list has the same number of entries as the csi-SSB-ResourceList field.

For example, the UE receives a CSI-ResourceConfig associated with a CSI-SSB-ResourceSet IE that includes a list of SSB indices and associated PCIs. For example, if csi-SSB-ResourceList= [SSB index-7, SSB index-3, SSB index-7] and additionalPCIList-r17= [3, 5, 6], the UE is configured according to the following:
SSB index-7 of the PCI indexed=3;
SSB index-3 of the PCI indexed=5; and
SSB index-7 of the PCI indexed=6.

In this Rel-17 solution, even if the CSI resource configuration may include resources from multiple PCIs, the CSI-SSB-ResourceSet IE is generated by the UE's serving DU based on PCIs of cells that it provides. Currently, however, there is no capability to configure CSI-RS (or SSB) resources in L1/L2 mobility candidate cells provided by other (neighbor) DUs, i.e., for inter-DU cell changes.

Embodiments of the present disclosure address these and other problems, difficulties, and/or issues by providing flexible and efficient signaling techniques that facilitate configuring the UE for intra-CU/inter-DU L1/L2 based inter-cell mobility. At a high level, embodiments include communication between the UE, the CU serving the UE, the DU serving the UE, and at least one neighbor DU being requested by the CU to configure one or more L1/L2 inter-cell mobility candidate cells for the UE.

For example, the UE can receive an RRC message including a CSI resource configuration for performing CSI measurements for L1/L2 inter-cell mobility. The CSI resource configuration includes CSI (or SSB) resources to be measured by the UE, particularly CSI resources in an L1/L2 inter-cell mobility candidate cell provided by a different DU than the DU currently providing the UE's serving cell(s). The UE performs the configured measurements and transmits to the network a CSI report including the measurements, to assist the network's L1/L2 inter-cell mobility decisions on a candidate cell and/or a candidate beam of a candidate cell. The CSI resource configuration for the candidate cell can be generated by the non-serving DU, which provides the candidate cell.

Embodiments can provide various benefits and/or advantages. For example, embodiments can facilitate configuring a UE with CSI measurement resources for one or more L1/L2 inter-cell mobility candidate cells (also referred to as “L1/L2 inter-cell mobility candidates”) associated with a neighbor DU, on which the UE can perform and report mobility measurements to the network. These CSI reports facilitate L1/L2 inter-cell mobility decisions by the network, which enables the UE to move further in its coverage area. This promotes more efficient signaling, reduced processing, and reduced interruption time compared to a L3 handover/reconfiguration with sync. Moreover, embodiments also maintain L1/L2 mobility interoperability between the UE, the serving DU/CU, and the neighbor DU without ambiguities.

In the present disclosure, the following terms may be used interchangeably: “L1/L2 based inter-cell mobility” (as used in the 3GPP Work Item), “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower-layer (i.e., below RRC, such as MAC or PHY) signaling from a network indicating for the UE to change of its serving cell (e.g., PCell) from a source cell to a target cell. Compared to conventional RRC signaling, lower layer signaling reduces processing time and interruption time during mobility and may also increase mobility robustness since the network can respond more quickly to changes in the UE's channel conditions.

Another relevant aspect in L1/L2 inter-cell mobility is that a cell can be associated with multiple SSBs (or beams), with different SSBs being transmitted in different spatial directions during a half frame, thereby spanning the coverage area of a cell. A cell may also be associated with multiple CSI-RS resources, which may be transmitted in different spatial directions. Hence, in L1/L2 inter-cell mobility, the reception of lower layer signaling indicating for the UE to change from one beam in its serving cell to another beam in a (candidate) neighbor cell, which also involves changing serving cell.

In the present disclosure, the following terms may be used interchangeably with respect to L1/L2 inter-cell mobility: “neighbor DU,” “non-serving DU,” and “candidate DU.” The following description refers to one or more configurations generated by a neighbor DU, that are encapsulated in an RRCReconfiguration message, which is received by the UE when configured for inter-DU L1/L2 inter-cell mobility. The configuration(s) can include various information according to different embodiments summarized below.

In the present disclosure, the term “CSI resource configuration” refers to a configuration of, for, and/or associated with one or more CSI resources to be measured by the UE for CSI reporting, specifically for CSI resources of an L1/L2 inter-cell mobility candidate cell. A “resource” may be one or more SSB, one or more CSI-RS, etc. A configured resource may be associated with a particular candidate cell by an identifier, identity, index, etc. included in the CSI resource configuration.

In the present disclosure, the term “reference signal” (abbreviated as “RS”) includes any signals with a known content or pattern that can be measured by a UE, including but not limited to CSI-RS, DM-RS, synchronization signals (SS, e.g., SSB), etc.

In the present disclosure, the term “CSI measurement” refers to a UE measurement based on a CSI resource configuration, from which the UE derives information to include in a CSI report. Such a CSI report may assist the network's L1/L2 inter-cell mobility decisions for the UE. In the present context, a CSI measurement is different than a radio resource management (RRM) measurement reported in an RRC Measurement Report message defined in 3GPP TS 38.331. For example, an RRM measurement is configured by an RRC measurement configuration (MeasConfig IE in an RRCReconfiguration message), is L3 filtered, is used as input to trigger an RRC Measurement Report, and once reported, is typically used by the network (e.g., the CU) to determine whether the UE needs to be handed over to another cell or not, with an L3 (RRC) procedure called Reconfiguration with Sync.

In contrast, a CSI measurement is configured by a CSI measurement configuration (e.g., CSI-MeasConfig-L1-L2-Mobility), is not necessarily L3 filtered by the UE, is not used as input to trigger an RRC Measurement Report but instead is used as input to derive information that is included in a CSI report, which is a layer lower message sent via PUCCH or PUSCH (e.g., as defined in 3GPP TS 38.214). A CSI report can be used in the network's L1/L2 inter-cell mobility decisions and procedures, such as for determining whether the UE needs to be switched to a beam (and/or SSB, TCI state, QCL source, etc.) of a candidate cell in a L1/L2 inter-cell mobility procedure.

In some embodiments, a CSI measurement can include Synchronization Signal Reference Signal Received Power (SS-RSRP) of a L1/L2 inter-cell mobility candidate cell, for at least one configured/indicated SSB of the L1/L2 inter-cell mobility candidate cell. The SS-RSRP is measured only among the reference signals corresponding to SS/PBCH blocks (SSBs) with the same SS/PBCH block (SSB) index and the same physical-layer cell identity (PCI) of the L1/L2 inter-cell candidate cell.

In some embodiments, the SS-RSRP may be derived as the linear average over the power contributions (in [W]) of the resource elements that carry secondary synchronization signals (SSs) of the L1/L2 inter-cell candidate cell. In some embodiments, the SS-RSRP determination is based on the demodulation reference signals (DMRS) for PBCH of the L1/L2 inter-cell candidate cell; and, if indicated by higher layers, CSI reference signals of the L1/L2 inter-cell candidate cell, in addition to secondary synchronization signals may be used.

In some embodiments, the SS-RSRP indicate certain SS/PBCH blocks for performing SS-RSRP measurements, then SS-RSRP is measured only from the indicated set of SS/PBCH block(s). In some embodiments, the SS-RSRP is used for L1-RSRP to be included in a CSI report.

In some embodiments, a CSI measurement can include one or more of the following:
SS reference signal received quality (SS-RSRQ) of a L1/L2 inter-cell mobility candidate cell, for at least one configured/indicated SSB of the L1/L2 inter-cell mobility candidate cell;
SS signal-to-noise and interference ratio (SS-SINR) of a L1/L2 inter-cell mobility candidate cell, for at least one configured/indicated SSB of the L1/L2 inter-cell mobility candidate cell; and
CSI Reference Signal Received Power (CSI-RSRP) of a L1/L2 inter-cell mobility candidate cell, for at least one configured/indicated CSI-RS resource of the L1/L2 inter-cell mobility candidate cell.

In some of these embodiments, the CSI-RSRP comprises the linear average over the power contributions (in [W]) of the resource elements of the antenna port(s) that carry CSI reference signals configured for RSRP measurements within the considered measurement frequency bandwidth in the configured CSI-RS occasions, for the L1/L2 inter-cell mobility candidate cell.

In some embodiments, a CSI measurement can include one or more of the following:

CSI reference signal received quality (CSI-RSRQ) of a L1/L2 inter-cell mobility candidate cell, for at least one configured/indicated CSI-RS resource of the L1/L2 inter-cell mobility candidate cell.
CSI signal-to-noise and interference ratio (CSI-SINR) of a L1/L2 inter-cell mobility candidate cell, for at least one configured/indicated CSI-RS resource of the L1/L2 inter-cell mobility candidate cell.
Layer 1 Reference Signal Received Power (L1-RSRP) based on at least one SSB of a L1/L2 inter-cell mobility candidate cell.
Layer 1 Reference Signal Received Power (L1-RSRP) based on at least one CSI-RS resource of a L1/L2 inter-cell mobility candidate cell.
Layer 1 SINR (L1-SINR) based on at least one SSB of a L1/L2 inter-cell mobility candidate cell.
Layer 1 SINR (L1-SINR) based on at least one CSI-RS resource of a L1/L2 inter-cell mobility candidate cell.
Channel Quality Indicator (CQI) of a L1/L2 inter-cell mobility candidate cell, based on SSB and/or CSI-RS in the CSI resource configuration;
precoding matrix indicator (PMI) of a L1/L2 inter-cell mobility candidate cell, based on SSB and/or CSI-RS in the CSI resource configuration;
CSI-RS resource indicator (CRI) of a L1/L2 inter-cell mobility candidate cell, based on SSB and/or CSI-RS in the CSI resource configuration;
SS/PBCH Block Resource indicator (SSBRI) of a L1/L2 inter-cell mobility candidate cell, based on SSB and/or CSI-RS in the CSI resource configuration;
Layer indicator (L1) of a L1/L2 inter-cell mobility candidate cell, based on SSB and/or CSI-RS in the CSI resource configuration;
Rank indicator (RI) of a L1/L2 inter-cell mobility candidate cell, based on SSB and/or CSI-RS in the CSI resource configuration.

In some embodiments, a CSI measurement configuration can include (or be associated with) criteria and/or conditions that trigger reporting of CSI measurements, which can be referred to as a “reporting configuration”. In some embodiments, the reporting configuration can also include one of more of the following:
Configuration of physical UL channels (e.g., PUCCH and/or PUSCH) on which the UE transmits a CSI report;
Configuration of one or more quantities and/or metrics (e.g., RI, CQI, SSBRI, CRI, L1-RSRP, L1-RSRQ, L1-SINR) to be measured based on SSB(s) and/or CSI-RS resource(s) of a L1/L2 inter-cell mobility candidate cell, and to be included in the CSI report.

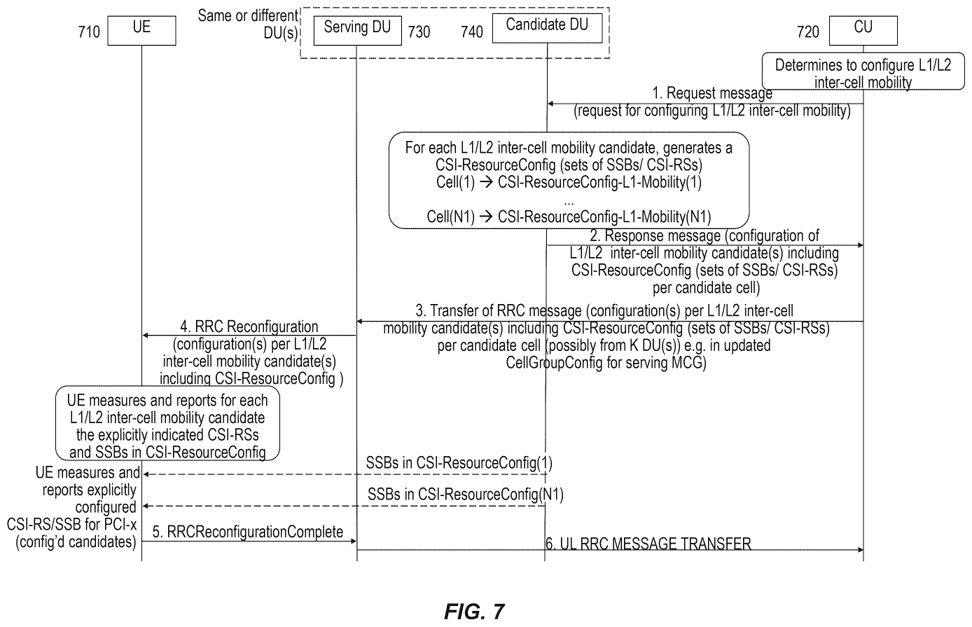

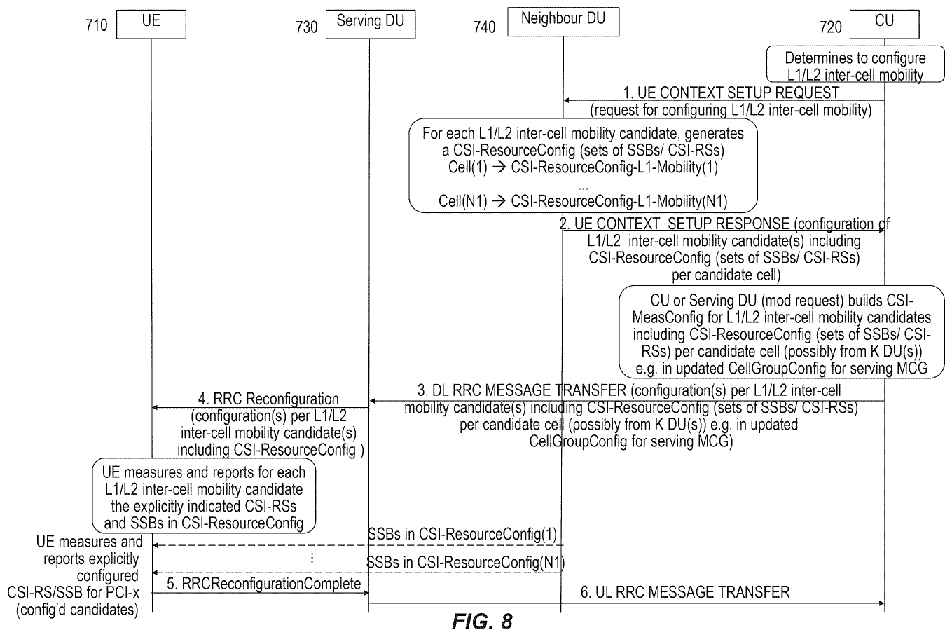

FIG. 7 shows a signaling diagram of a procedure between a UE (710), a serving DU (730), a candidate DU (740), and a CU (720), according to various embodiments of the present disclosure. This diagram will be used as context for the following description.

In some embodiments, the UE is configured by the network, for each L1/L2 inter-cell mobility candidate cell, with a CSI resource configuration comprising at least one set of RS that may be beamformed and transmitted in different spatial directions (e.g., list of SSBs and/or CSI-RS resources). Each configured RS (or set) is measured by the UE (e.g., as listed above) and can be reported to the network according to a reporting configuration associated with the CSI measurement configuration. For example, the reporting can include the UE deriving a CSI report to be sent to the network based on the measurements performed.

The RS configured to be measured are associated with an L1/L2 inter-cell mobility candidate cell information by a cell identifier (e.g., Physical Cell Identity-PCI) and/or frequency information (e.g., RS frequency, SS frequency, SSB frequency, CSI-RS initial frequency resource and bandwidth, etc.).

In some embodiments, the UE transmits a CSI report to the network based on reporting criteria (e.g., periodic, aperiodic, semi-persistent) included in the reporting configuration. The reporting configuration may refer to and/or indicate the RS to be measured either directly or indirectly. Based on the CSI report, the network may decide to trigger L1/L2 inter-cell mobility for that UE. In such case, the network transmits lower layer signaling indicating the UE should switch its serving cell and/or beam (e.g., TCI state).

In some embodiments, the CSI resource configuration is generated by a candidate DU that provides the L1/L2 inter-cell mobility candidate cell. The candidate DU generates the CSI resource configuration(s) in response to a request by the CU to configure an L1/L2 inter-cell mobility candidate for the UE. The candidate DU also transmits the set of RS to be measured by the UE, according to the CSI resource configuration.

In various embodiments, the candidate DU receives a message (e.g., UE Context Modification Request over F1AP) from the CU including the request to configure the UE with L1/L2 inter-cell mobility. In response, the candidate DU generates the CSI resource configuration indicating the set of RS to be measured by the UE, for each L1/L2 inter-cell mobility candidate cell provided by the candidate DU. The candidate DU includes the CSI resource configuration in a response message e.g., UE Context Modification Response) sent to the CU.

In some embodiments, the candidate DU may be the UE's serving DU, i.e., the DU that provides the UE's current special Cell (SpCell), PCell (for MCG), or PSCell (for SCG). In other embodiments, the candidate DU may be a neighbor DU, i.e., a DU that does not provide the UE's current special Cell (SpCell), PCell (for MCG), or PSCell (for SCG).

FIG. 8 shows a signaling diagram of a procedure between a UE (710), a serving DU (730), a candidate DU (740), and a CU (720), according to embodiments in which the candidate DU is a neighbor DU. Although the operations in FIG. 8 are given numerical labels, this is intended to facilitate the following description rather than to require or imply any particular sequential order, unless expressly stated otherwise.

In operation 1, the CU determines to configure a UE, which is connected to it and is capable of L1/L2 inter-cell mobility, with at least one L1/L2 inter-cell mobility candidate. In some embodiments, the CU may determine one or more candidate cells and the associated DU, which is the neighbor DU in this case. The CU transmits a request (e.g., UE CONTEXT SETUP REQUEST message over F1AP) for the neighbor DU to configure at least one L1/L2 inter-cell mobility candidate cell for the UE. In response to the message, the neighbor DU generates for each L1/L2 inter-cell mobility candidate cell, a CSI resource configuration for a set of RS to be measured and reported by the UE to support L1/L2 inter-cell mobility decisions by the network. In some embodiments, the CSI resource configuration can include a plurality of IEs CSI-ResourceConfig-L1-Mobility (k,n), where k is the index of the resource configuration for the nth L1/L2 inter-cell mobility candidate cell provided by the neighbor DU. In various embodiments, each instance of the IE includes one or more of the following:
resource configuration identifier (e.g., a resource config Id, CSI-ResourceConfigId, possibly encoded as an integer);
one or more SS and/or groups/sets of SS, e.g., SSB index-1, SSB index-2, SSB index-64, . . . , SSB index-Z. In one option the UE is configured with lists of SSB sets, wherein each set has a set identifier, and each SSB within the set is indicated by an SSB index, e.g., SSB Set id=1 with SSB index-1, SSB index-2, SSB index-3, and SSB Set id=7 with SSB index-1, SSB index-4, SSB index-5, SSB index-7.
one or more groups/sets of RS, such as CSI-RS. In one option the UE is configured with lists of CSI-RS resources sets, wherein each set has a set identifier, and each CSI-RS within the set is indicated by a CSI-RS resource index. In this case, further configuration per CSI-RS resource is also indicated to the UE, such as the CSI-RS initial frequency (e.g., initial Physical Resource Block (PRB), possibly in relation to an absolute frequency like point A defined in 3GPP TS 38.331), bandwidth (e.g., number of PRBs from the initial frequency), subcarrier spacing, etc.
bandwidth part (BWP) identifier;
resource type indication (e.g., periodic, aperiodic, semi-persistent), which indicates to the UE how the resource being configured is being transmitted by the candidate DU.
indication of the L1/L2 inter-cell mobility candidate associated with the resources being configured, e.g., cell identifier, candidate cell identifier index, etc.

In operation 2, the neighbor DU transmits to the CU a message (e.g., UE CONTEXT SETUP RESPONSE over F1AP) including the CSI resource configuration prepared for the UE.

In some embodiments, after operation 2, the CU transmits a message (e.g., UE Context Modification Request) to the UE's serving DU and receives a response (e.g., UE Context Modification Response) including a CSI reporting configuration for one of the UE's configured serving cells (e.g., PCell or SCell), e.g., for reporting CSI over the UL channel of that serving cell. The CSI reporting configuration is associated with a resource configuration of a L1/L2 inter-cell mobility target candidate, so that the UE measures configured resources of the L1/L2 inter-cell mobility candidate (e.g., an SSB-x of candidate cell A) and reports CSI over the UL channel of the serving cell.

In some embodiments (between steps 2 and 3), the CU generates a CSI reporting configuration, including the resource configuration(s) from the neighbor DU. In some embodiments, the CSI measurement configuration, comprising resource configurations for L1/L2 inter-cell mobility candidate cell(s) and reporting configuration for one of the UE's configured serving cell (e.g., for reporting CSI measurements on an UL channel of one of the serving cells) is configured by the CU, and included in the RRCReconfiguration message sent to the UE in operation 4 (below). For example, the CSI measurement configuration for L1/L2 inter-cell mobility candidate cell(s) is configured outside the Cell Group Configuration (e.g., MCG configuration). In some embodiments, the CSI measurement configuration may be within the RRC MeasConfig IE, which contains a measurement configuration for RRC measurements and RRC measurement reports.

In some embodiments, the CSI-ResourceConfig-L1-Mobility IE for the k-th resource configuration of the n-th L1/L2 inter-cell mobility candidate cell may be the k-th element of a list of resource configurations (e.g., an AddMod list) defined for each candidate cell. For example, the list may be a SEQUENCE (SIZE (1 . . . . Z)) OF CSI-ResourceConfig-L1-Mobility in ASN.1 encoding. That may simplify how each candidate DU generates the resource configurations for each L1/L2 inter-cell mobility candidate cell and how the CU combines different resource configurations from different candidate DUs when generating an RRCReconfiguration to be provided to the UE.

In the example shown in FIG. 8, there are n CSI-ResourceConfig-L1-Mobility IEs corresponding to n candidate cell of the neighbor DU, with each candidate cell having only one resource configuration (k=1). In the case of multiple resource configurations per candidate cell, with each candidate cell having a list, the overall configuration for multiple candidates may be a list of N elements, wherein each element (n-th element) refers to the target candidate cell for L1/L2 inter-cell mobility, and within each element, there may be a list of resource configurations associated to the n-the cell. For example, this could be structured in vector form as CSI-ResourceConfig-L1-Mobility (1,n), CSI-ResourceConfig-L1-Mobility (2,n) . . . . CSI-ResourceConfig-L1-Mobility (Kₙ,n).

In some embodiments, the CSI resource configuration per candidate cell is provided by the candidate DU to the CU in an RRC container within the response message (e.g., UE CONTEXT SETUP RESPONSE or UE CONTEXT MODIFICATION RESPONSE). In one example, that RRC container may be part of a “DU to CU RRC Information” which contains RRC Information sent from DU to CU over F1AP.

In some embodiments, the CU includes the RRC Container from the neighbor DU in an RRCReconfiguration message (e.g., in an IE), without having to contact the serving DU before generating the RRCReconfiguration message for the UE. If the CU has requested L1/L2 inter-cell mobility to more than one neighbor DU, it may include the RRC Containers for all candidate DUs in the same RRCReconfiguration message to the UE. In one example, these RRC Containers would be outside the CellGroupConfig IE (for the UE's current serving cell), such as part of the CSI configuration outside CSI-MeasConfig IE. As an example, the CU may also generate a CSI reporting configuration associated with the resource configuration per L1/L2 inter-cell mobility candidate cell, which may be included in the RRCReconfiguration message separately from the RRC containers received from the candidate DU. Reduced latency is one benefit of this approach, since there is no need to send that from CU to the serving DU, and back to the CU, to then be included in the RRCReconfiguration sent to the UE via the serving DU.

In some embodiments, the CU indicates the RRC container from the neighbor DU to the serving DU, in a message (e.g., UE CONTEXT MODIFICATION REQUEST over F1AP). Upon reception the serving DU generates a CSI measurement configuration (e.g., updated version of current CSI-MeasConfig IE, within CellGroupConfig, or other CSIMeasConfig-L1-L2-Mobility IE defined for L1/L2 inter-cell mobility) including the configuration of the resources of the L1/L2 inter-cell mobility candidate cells to be measured by the UE. The serving DU sends the CSI measurement configuration to the CU in a response message (e.g., UE CONTEXT MODIFICATION RESPONSE over F1AP). In addition, the serving DU may include in the CSI measurement configuration an association between the resources (or resource sets) being configured by the candidate DU for the candidate cells and reporting configuration(s) determined by the serving DU, indicating how CSI associated with the configured resources are to be reported (e.g., via PUSCH and/or PUCCH, periodic/aperiodic/semi-persistent, etc.). Upon reception, the CU generates an RRCReconfiguration message including the updated version of the CSI measurement configuration provide by the serving DU and transmits it to the UE via the serving DU.

In some embodiments, the CSI resource configuration comprising the CSI-ResourceConfig-L1-Mobility IEs for each resource configuration of each L1/L2 inter-cell mobility candidate cell is not provided to the CU in an RRC container to be directly provided to the UE. In these embodiments, the IEs are first processed by the serving DU, which generates an updated version of the UE's current CSI-MeasConfig IE, including the resources to be measured from L1/L2 inter-cell mobility candidate cells. Upon reception of the CSI resource configuration from the neighbor DU, the CU transmits the received CSI resource configuration to the serving DU (e.g., in a UE CONTEXT MODIFICATION REQUEST message). The serving DU generates an updated version of the CSI measurement configuration (e.g., IE CSI-MeasConfig) and transmits it to the CU in a response message (e.g., UE CONTEXT MODIFICATION RESPONSE). The CU generates the RRCReconfiguration message including the updated CSI measurement configuration (e.g., in CellGroupConfig IE) and transmits it to the UE via the serving DU (e.g., DL RRC MESSAGE TRANSFER).

In some embodiments, the content within the CSI-ResourceConfig-L1-Mobility IE for each resource configuration of each L1/L2 inter-cell mobility candidate cell is provided to the CU in an IE of the message from the neighbor DU, e.g., as one or more IE(s) within the UE CONTEXT SETUP RESPONSE message. In that case, for example, the CU may generate a CSI measurement resource configuration for the UE including the configuration of the set of RS to be measured and reported by the UE for each L1/L2 inter-cell mobility candidate cell outside or within the UE's Cell Group configuration.

In operation 3, the CU transmits a message (e.g., DL RRC MESSAGE TRANSFER over F1AP) to the serving DU including an RRCReconfiguration message intended for the UE which includes, per L1/L2 inter-cell mobility candidate cell, the configuration of the set of RS to be measured and reported by the UE for CSI. As described above in relation to operation 2, the CU may transmit that message to the serving DU after having performed another procedure for obtaining a configuration from the serving DU to be included in the RRCReconfiguration message for the UE, configuring the UE with the resource configurations per L1/L2 inter-cell mobility candidate cells, and associated CSI reporting configuration(s).

In operation 4, the UE receives the RRCReconfiguration message the CSI resource configuration per L1/L2 inter-cell mobility candidate, including the configuration of RS to be measured and reported by the UE for CSI. Within various IE(s), fields, and/or parameters of the RRCReconfiguration message, the UE obtains a configuration of each L1/L2 inter-cell mobility candidate cell to be applied (or switched to) upon receiving lower layer signaling (e.g., MAC CE or DCI) indicating that the UE should switch to a L1/L2 inter-cell mobility candidate cell and/or a TCI state of a L1/L2 inter-cell mobility candidate cell.

The relevant IEs, fields, and/or parameters included in the RRCReconfiguration message can be generated by the CU and/or by the serving DU in various ways as described above, and the UE can be configured in a corresponding manner to extract the relevant information from the IEs, fields, and/or parameters of the RRCReconfiguration message. Some examples of signaling alternatives include:
Resource configuration per L1/L2 inter-cell mobility candidate received together with the L1/L2 inter-cell mobility candidate cell configuration;
Resource configuration per L1/L2 inter-cell mobility candidate received in same level as L1/L2 inter-cell mobility candidate cell configuration;
8 Resource configuration per L1/L2 inter-cell mobility candidate within updated version of UE's CSI measurement configuration for a serving cell e.g., PCell.

In some embodiments, the RRCReconfiguration message includes the CSI resource configuration per L1/L2 inter-cell mobility candidate outside of both the current cell group configuration (e.g., CellGroupConfig IE) and the current serving cell configuration (e.g., ServingCellConfig IE).

In some embodiments, the CSI resource configuration per L1/L2 inter-cell mobility candidate cell is received by the UE together with the L1/L2 inter-cell candidate cell configuration. For example, assume that for configuring each L1/L2 inter-cell mobility candidate cell the UE receives in the RRCReconfiguration an L1-Mobility-candidateToAddMod IE that includes an identifier of the candidate configuration (e.g., candidateConfigId), the RRC configuration to be applied by the UE upon reception of lower layer signaling indicating the L1/L2 inter-cell mobility execution. In the L1-Mobility-candidateToAddMod IE, with the configuration to be applied upon execution, the UE also receives the CSI resource configuration associated with that L1/L2 inter-cell mobility candidate cell. For example, this can be carried in a resourceConfigToAddModList defined as a SEQUENCE of CSI-ResourceConfig-L1-Mobility, as discussed above.

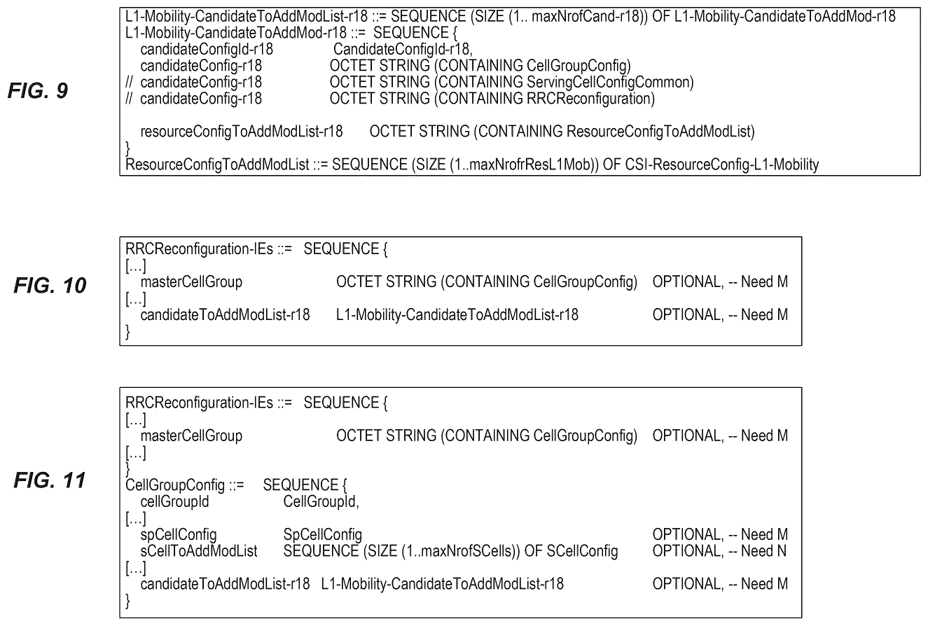

In some embodiments, the CSI resource configuration per L1/L2 inter-cell mobility candidate cell is received by the UE outside the UE's CellGroupConfig in an IE OCTET STRING (CONTAINING ResourceConfigToAddModList), which may indicate that this IE has been generated by a neighbor DU but the CU added the CSI resource configuration per L1/L2 inter-cell mobility candidate cell in the RRC Reconfiguration message. FIG. 9 shows an exemplary ASN.1 data structure according to these embodiments.

In this example the configuration per candidate to be applied by the UE upon L1/L2 inter-cell mobility execution is modelled as a cell group configuration (e.g., CellGroupConfig IE), which includes a cell configuration (e.g., ServingCellConfig IE). In other words, when the UE receives lower layer signaling (e.g., MAC CE or DCI) indicating that the UE should switch to a L1/L2 inter-cell mobility candidate cell and/or a TCI state of a L1/L2 inter-cell mobility candidate cell, the UE changes from its currently active CellGroupConfig to the CellGroupConfig of the indicated L1/L2 inter-cell mobility candidate cell by applying the CellGroupConfig of the indicated L1/L2 inter-cell mobility candidate cell.

These embodiments are not limited, so a serving cell configuration or a TCI state configuration could be used instead of a cell group configuration. In that case, when the UE receives lower layer signaling (e.g., MAC CE or DCI) indicating that the UE should switch to a L1/L2 inter-cell mobility candidate cell and/or a TCI state of a L1/L2 inter-cell mobility candidate cell, the UE changes from its currently active serving cell configuration to the serving cell configuration of the indicated L1/L2 inter-cell mobility candidate cell (including applying dedicated serving cell configuration and cell-specific/common serving cell configuration).

FIG. 10 shows an exemplary ASN.1 data structure for configuration of L1/L2 inter-cell mobility candidate cells in which configurations for one or more candidates, possibly in a list, would be outside the outside the CellGroupConfig IE. FIG. 11 shows an exemplary ASN.1 data structure for configuration of L1/L2 inter-cell mobility candidate cells in which configurations for one or more candidates, possibly in a list (e.g., L1-Mobility-candidateToAddModList) would be outside the serving cell Configuration but within the CellGroupConfig IE.

The L1/L2 inter-cell mobility candidate cell may be a serving cell, such as a primary cell, a Special Cell and/or a Secondary Cell. The resources being configured may be associated to one or more of the serving cells being configured as candidate cells for L1/L2 inter-cell mobility.

An example of a nested structure for the signaling is show below. The CSI resource configuration per L1/L2 inter-cell mobility candidate cell is provided to the UE together with the configuration per L1/L2 inter-cell mobility candidate cell to be used upon switching to that candidate in L1/L2 inter-cell mobility execution, but not within the candidate configuration. In particular, it is outside both the cell group configuration and the serving cell configuration.
RRC Reconfiguration
   Cell Group Configuration e.g. for the Master Cell Group
      List of target candidate cell configuration for that cell group
         Configuration per target candidate cell (1) of IE L1-Mobility-CandidateToAddMod
         . . .
         Configuration per target candidate cell (n) IE L1-Mobility-Candidate ToAddMod
         . . .
         Configuration per target candidate cell (N) IE L1-Mobility-Candidate ToAddMod
      SpCell configuration
      List of Scell configuration(s)
Configuration for target candidate cell (n)
   Target candidate configuration identifier
   Configuration to be applied or switched to upon L1/L2 inter-cell mobility execution e.g. Candidate CellGroupConfig or candidate ServingCellConfig
   Resource Configuration(s) for CSI measurements of candidate cell

In some embodiments, the RRCReconfiguration message includes the CSI resource configuration per L1/L2 inter-cell mobility candidate outside the L1/L2 inter-cell mobility candidate cell configuration but associated with it in some manner. This can be done, for example, by including an identifier of the L1/L2 inter-cell mobility candidate cell in the CSI resource configuration, so the UE knows which candidate cell to measure for a given CSI resource configuration.

For example, assume that for configuring each L1/L2 inter-cell mobility candidate cell the UE receives in the RRCReconfiguration an L1-Mobility-candidateToAddMod IE that includes an identifier of the candidate configuration (e.g., candidateConfigId) to be applied by the UE upon reception of lower layer signaling indicating the L1/L2 inter-cell mobility execution. In the same message but outside of the L1-Mobility-candidateToAddMod IE, the UE also receives the CSI resource configuration associated with that L1/L2 inter-cell mobility candidate cell. For example, this can be carried in a resourceConfigToAddModList defined as a SEQUENCE of CSI-ResourceConfig-L1-Mobility, as discussed above.

The location of the CSI resource configuration per candidate cell outside Cell Group Config may indicate that it was generated by the CU and/or by the neighbor DU, rather than the serving DU. This may not prevent the serving DU involvement, such as for providing the CSI reporting configuration (in the serving cell) for the L1/L2 inter-cell mobility measurements configured by the CSI resource configuration from the neighbor DU.

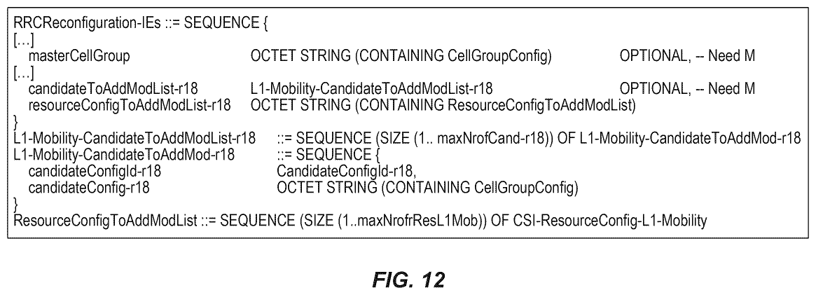

FIG. 12 shows an exemplary ASN.1 data structure for configuration of L1/L2 inter-cell mobility candidate cells, according to these embodiments. An example of a nested structure for the signaling is shown below. The CSI resource configuration per L1/L2 inter-cell mobility candidate cell is provided to the UE at the same level as the configuration per L1/L2 inter-cell mobility candidate cell to be used upon switching to that candidate in L1/L2 inter-cell mobility execution.
RRC Reconfiguration
   Cell Group Configuration e.g. for the Master Cell Group
      SpCell configuration
      List of Scell configuration(s)·
   List of target candidate cell configuration for that cell group
      Configuration per target candidate cell (1) of IE_{L1-Mobility-CandidateToAddMod}
      . . .
      Configuration per target candidate cell (n) IE L1-Mobility-Candidate ToAddMod
      . . .
      Configuration per target candidate cell (N) IE L1-Mobility-Candidate ToAddMod
   Resource Configuration(s) for CSI measurements of candidate cell

In some embodiments, the RRCReconfiguration message includes the CSI resource configuration per L1/L2 inter-cell mobility candidate inside both the current cell group configuration (e.g., CellGroupConfig) and the current serving cell configuration (e.g., ServingCellConfig IE).

In some embodiments, the CSI resource configuration per L1/L2 inter-cell mobility candidate is within the CSI measurement configuration for a current serving cell e.g., CSI-MeasConfig per serving cell configuration (e.g., within ServingCellConfig). For configuring each L1/L2 inter-cell mobility candidate cell, the UE receives in the RRCReconfiguration message a CellGroupConfig IE for a currently active cell group (e.g., MCG or SCG), which includes a ServingCellConfig IE for a current serving cell (e.g., PCell), which includes the CSI Measurement Configuration IE for L1/L2 inter-cell mobility measurements. That information includes the CSI resource configuration per L1/L2 inter-cell mobility candidate cell (e.g., as generated by the neighbor DU).

In some embodiments, the fact that the UE receives the CSI Measurement Configuration IE for L1/L2 inter-cell mobility measurements within a CellGroupConfig of the UE's current active cell group indicates that it has been generated by the serving DU. In one embodiment, the CU receives the CSI resource configuration per candidate from the neighbor DU (e.g., in a UE CONTEX SETUP RESPONSE), transmits a UE CONTEXT MODIFICATION REQUEST to the serving DU including the CSI resource configuration per candidate from the neighbor DU, and in response the CU receives from the serving DU a UE CONTEXT MODIFICATION RESPONSE including a Cell Group Configuration for the UE's current active cell group (e.g., current MCG), wherein within the CellGroupConfig there is a serving Cell Configuration (e.g., for the PCell) and a CSI measurement configuration within, wherein the CSI Measurement configuration includes the CSI resource configuration generated by the neighbor DU.

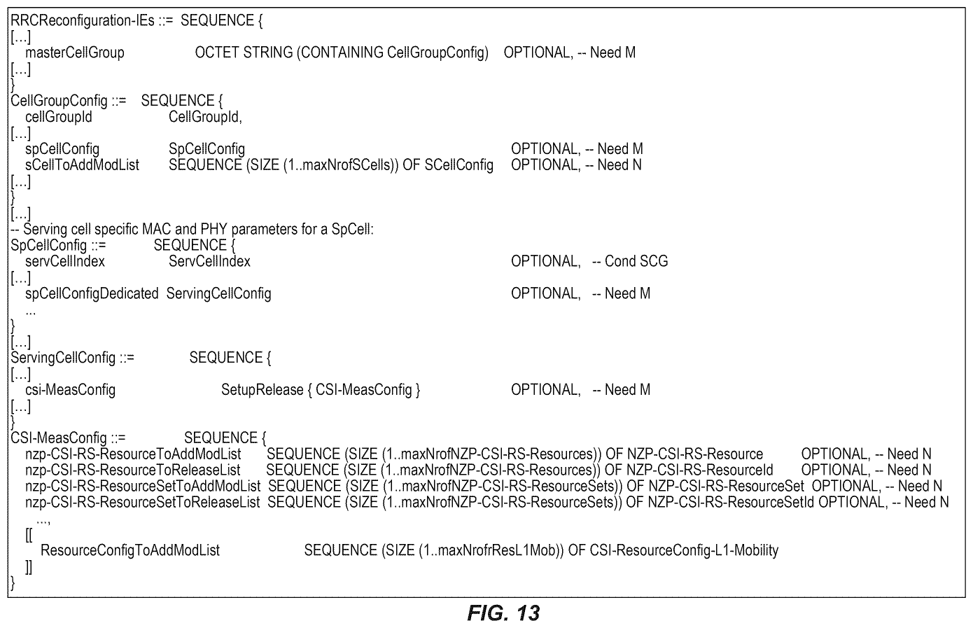

In some embodiments, the CSI resource configuration per L1/L2 inter-cell mobility candidate is received by the UE within a CSI-MeasConfig IE, which also includes the CSI measurement configuration for intra-cell mobility/beam management. FIG. 13 shows an exemplary ASN.1 data structure for configuration of L1/L2 inter-cell mobility candidate cells, according to these embodiments.

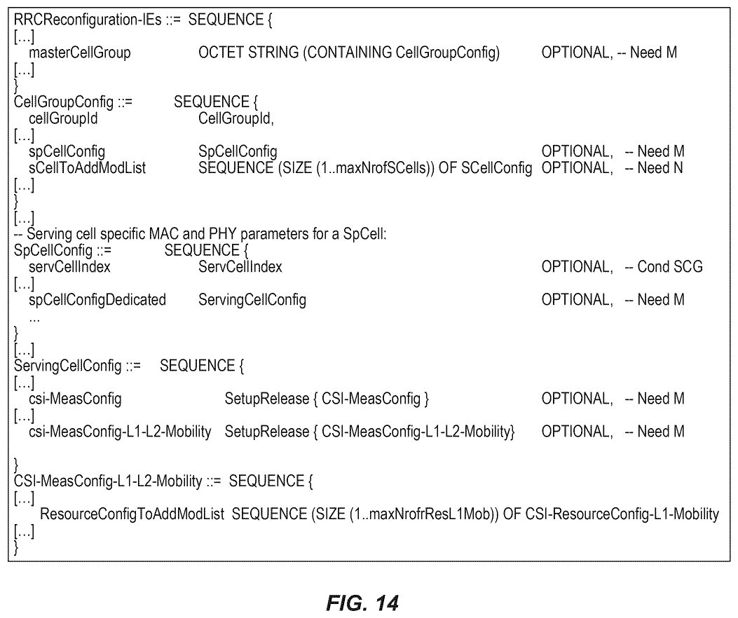

In other embodiments, the CSI resource configuration per L1/L2 inter-cell mobility candidate is received by the UE in an IE in the same level as CSI-MeasConfig IE. In other words, the CSI resource configuration is include in a serving cell configuration but may be defined specifically for CSI measurements on L1/L2 inter-cell mobility candidate cells. FIG. 14 shows an exemplary ASN.1 data structure for configuration of L1/L2 inter-cell mobility candidate cells, according to these embodiments.

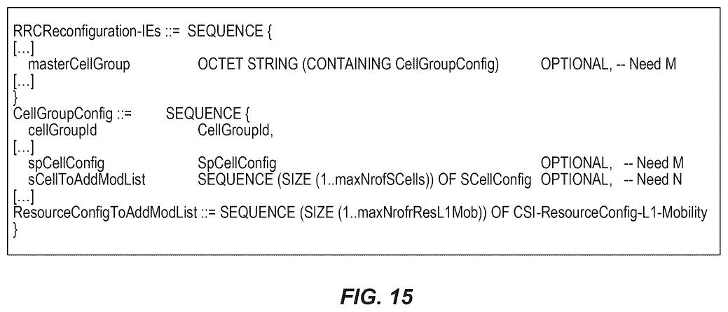

In other embodiments, the CSI resource configuration per L1/L2 inter-cell mobility candidate is received by the UE within a CellGroupConfig IE for a current UE cell group (e.g., MCG), but outside a serving cell configuration within that IE, as these refers to candidate configurations(s). Reporting configuration needs to indicate to which cell the report is meant to be transmitted. This requires the serving DU, which generates the serving cell configuration, to be informed by the CU of which resources are configured by the neighbor DU to be measured for L1/L2 inter-cell mobility. FIG. 15 shows an exemplary ASN.1 data structure for configuration of L1/L2 inter-cell mobility candidate cells, according to these embodiments.

In some embodiments, the CSI resource configuration per L1/L2 inter-cell mobility candidate, received by the UE, is associated with a CSI reporting configuration (e.g., a CSI-ReportConfig IE or a CSI-ReportConfig-L1-L2-Mobility IE). The association may be expressed in different ways, such as a CSI reporting configuration including an indication of the resource configuration of the L1/L2 inter-cell mobility candidate (e.g., an SSB or SSB set of a candidate cell).

In some embodiments, the reporting configuration is used to configure a CSI report including CSI information based on the one or more RSs (e.g., SSBs and/o CSI-RS resources) identified in the CSI resource configuration per L1/L2 inter-cell mobility candidate cell. CSI reporting may be configured as periodic, semi-persistent, or aperiodic report on PUCCH, PUSCH, or any other UL channel, on the cell in whose configuration the reporting configuration is included. Alternately, CSI reporting may be configured as semi-persistent or aperiodic sent on PUSCH or any other UL channel triggered by lower layer signaling (e.g., DCI or MAC CE) received on the cell in whose configuration the reporting configuration is included.

In some embodiments, the reporting configuration the UE receives for one of its configured serving cells (e.g., the PCell or PSCell), in the serving cell configuration within the UE's current Cell Group Config, refers to a configured L1/L2 inter-cell mobility candidate cell (cell identity or a candidate cell identity, or a candidate configuration identity), e.g., by including the CSI reporting configuration an identifier and/or index of the L1/L2 inter-cell mobility candidate cell. In this manner, the UE knows that a given CSI reporting configuration is associated with a CSI resource configuration for a particular L1/L2 inter-cell mobility candidate cell. The CSI reporting configuration may also include a resource configuration identifier, as for a given L1/L2 inter-cell mobility candidate there may be multiple resource configuration(s).

In some embodiments, the UE receives the CSI resource configuration per L1/L2 mobility candidate cell and associated CSI reporting configuration, performs one or more CSI measurement(s) (e.g., L1-RSRP, L1-SINR on an SS and/or RS configured for a candidate), and transmits a CSI report on a serving cell, including the CSI measurement(s).

In operations 5-6, after having received and applied the RRCReconfiguration message, the UE transmits an RRCReconfigurationComplete message to the CU via the serving DU. In some embodiments, that message is transmitted when/after the UE verifies that the CSI resource configuration per L1/L2 inter-cell mobility candidate cell is compliant, such as the configured measurements configured do not exceed the UE capabilities. In operation 6, the serving DU forwards the RRCReconfigurationComplete message to the CU in a UL RRC MESSAGE TRANSFER message over F1AP.

In some embodiments, the CU receives from the serving DU the message indicating that the UE has received the CSI resource configuration(s) per L1/L2 inter-cell mobility candidate cells as configured by the neighbor DU. In response, the CU transmits a message to the neighbor DU to indicate that. The neighbor DU, in response, may use that indication to start transmitting in the configured resources per L1/L2 inter-cell mobility candidate cell. This may be mainly relevant in the case of dedicated RS configured for that purpose, e.g., CSI-RS resources.

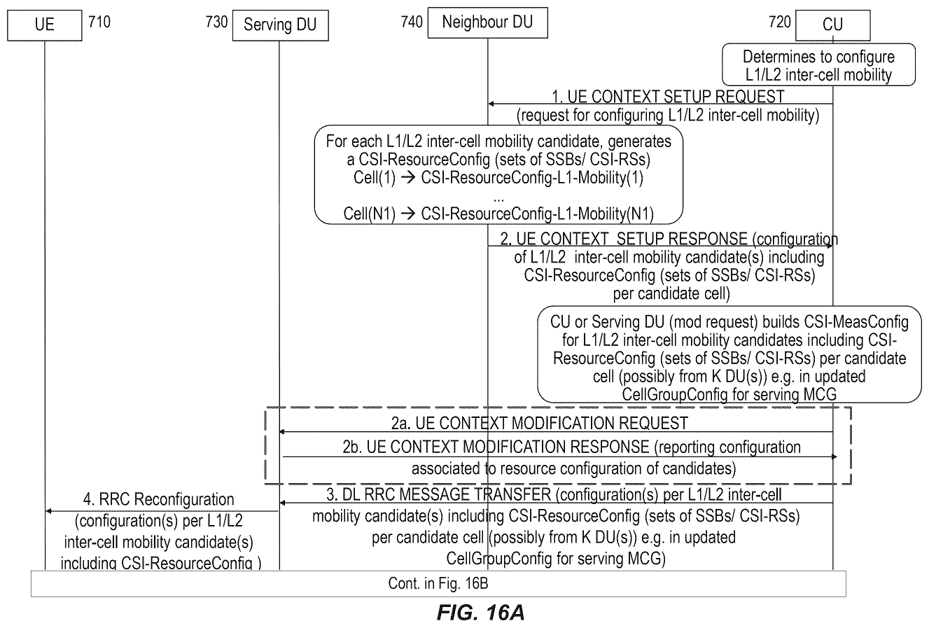

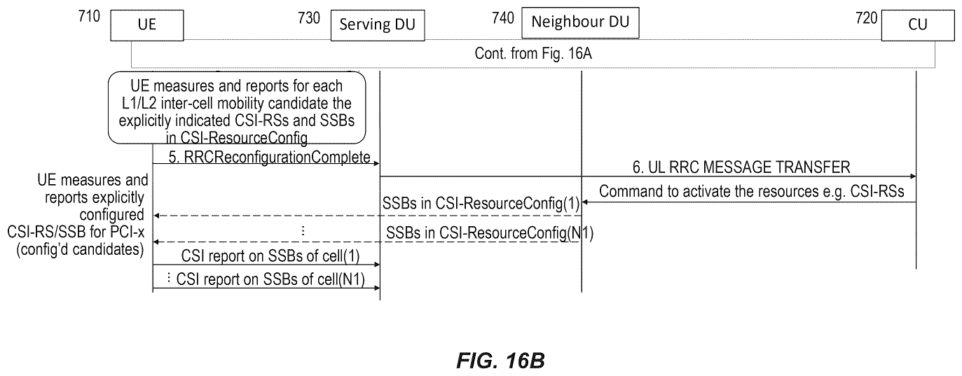

Some of the embodiments described above involved the serving DU generating configurations to be provided to the UE, including the CSI resource configuration per L1/L2 inter-cell mobility candidate cell. FIG. 16A-B shows a signaling diagram of a procedure between a UE (710), a serving DU (730), a neighbor (candidate) DU (740), and a CU (720), according to these embodiments.

In particular, FIG. 16B shows a command (“Command to activate the resources e.g., CSI-RSs”) sent from the CU to the neighbor DU after the CU receives the RRCReconfigurationComplete message from the UE. This command indicates the UE received the CSI resource configuration per L1/L2 inter-cell mobility candidate cell. Upon reception of that command, the neighbor DU may start transmitting the CSI resources which it has configured the UE to measure, as shown in FIG. 16B.

In other embodiments, the candidate DU may be the serving DU that provides the UE's current SpCell, PCell, or PSCell. In that case, the serving DU receives a request (e.g., UE Context Modification Request message over F1AP) from the CU to configure the UE with L1/L2 inter-cell mobility. In response, the serving DU generates the CSI resource configuration per L1/L2 inter-cell mobility candidate cell and includes it in a response message (e.g., UE Context Modification Response message) transmitted to the CU.

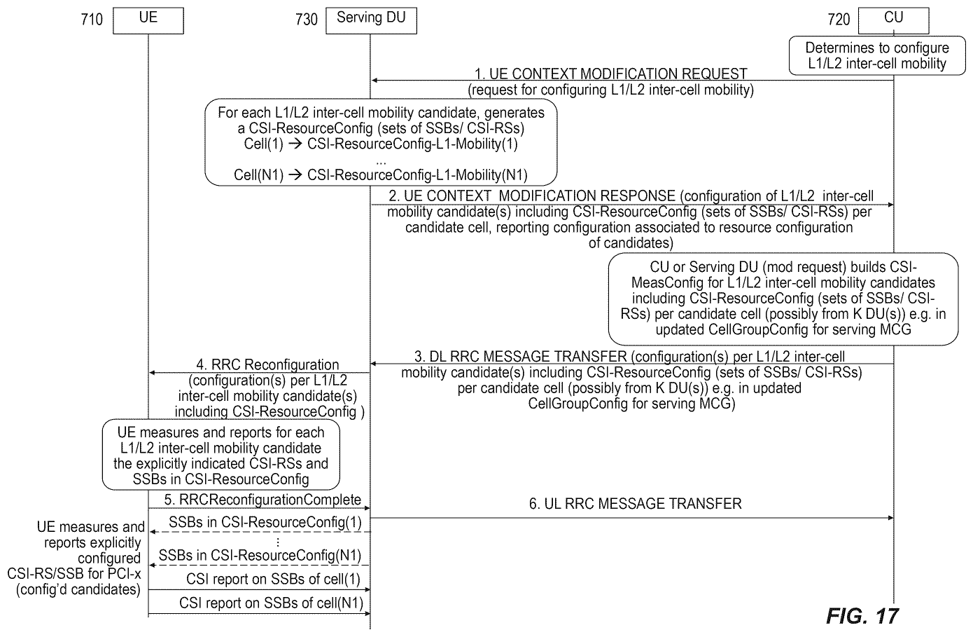

FIG. 17 shows a signaling diagram of a procedure between a UE (710), a serving (candidate) DU (730), and a CU (720), according to these embodiments. In general, the operations shown in FIG. 17 are substantially similar to those described above in relation to FIG. 8, including various embodiments, variations, and options. Two notable differences include:
In operation 1, the message sent from CU to serving DU over F1AP is a UE CONTEXT MODIFICATION REQUEST message instead of a UE CONTEXT SETUP REQUEST message. This is because the serving DU previously setup the context for the UE.
In operation 2, the message sent from serving DU to CU over F1AP is a UE CONTEXT MODIFICATION RESPONSE message instead of a UE CONTEXT SETUP RESPONSE message.
   In general, however, these messages may include any of the contents for various embodiments of messages for operations 1-2 described above in relation to FIG. 8. Similarly, the RRCReconfiguration message sent by the CU in operation 3 can include the CSI resource configuration per L1/L2 inter-cell mobility candidate cell and other information arranged in any of the ways described above in relation to FIG. 8 (e.g., RRC containers, etc.).

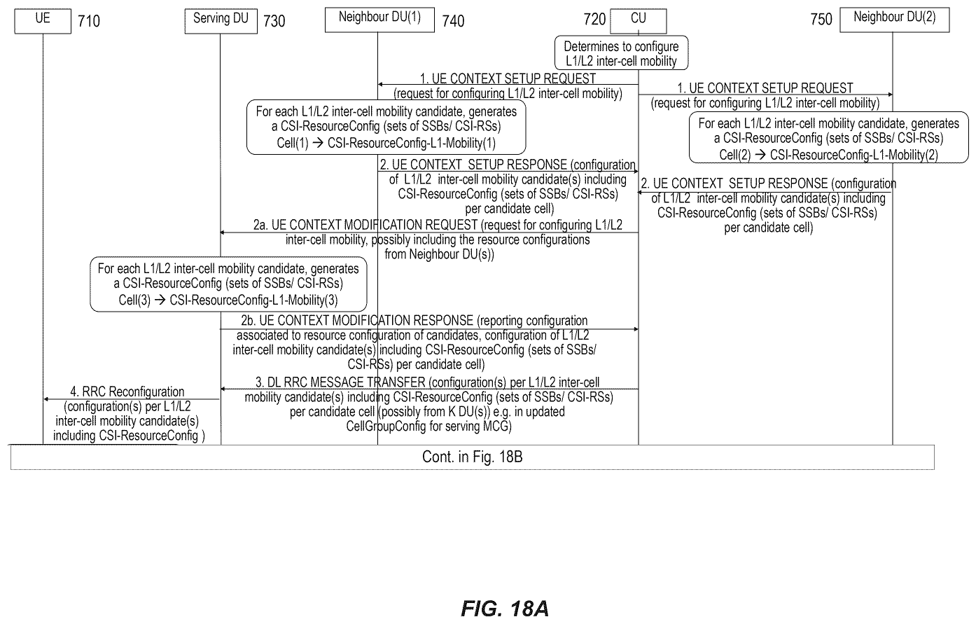

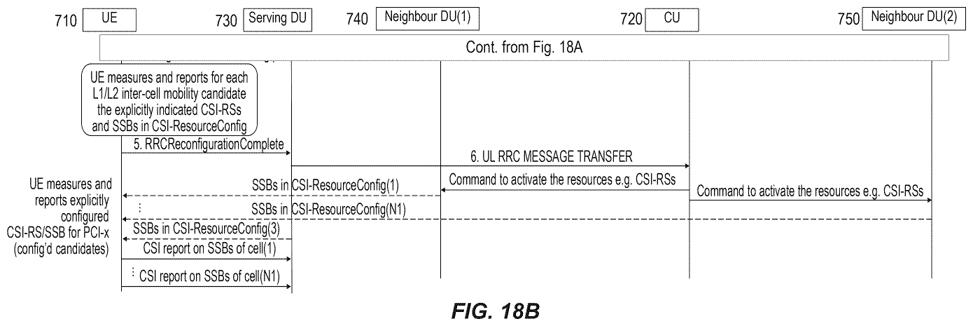

In other embodiments, there may be multiple candidate DUs, including the UE's serving DU one or more neighbor DUs, such as discussed above. FIG. 18A-B shows a signaling diagram of a procedure between a UE (710), a serving (candidate) DU (730), first and second neighbor (candidate) DUs (740, 750), and a CU (720), according to these embodiments. In general, the operations shown in FIG. 17 are substantially similar to those described above in relation to FIGS. 8 and 17, including various embodiments, variations, and options.

In particular, operations 1-2 performed by the CU with the respective neighbor DUs are similar to operations 1-2 in FIG. 8. Likewise, operations 2a-2b performed by the CU with the serving DU are similar to operations 2-3 in FIG. 17.

In some embodiments, the UE CONTEXT MODIFICATION REQUEST message received in operation 2b also includes one of more of the CSI resource configurations received from one or more neighbor DUs, e.g., in case the serving DU is responsible for including that in the Cell Group configuration.

In some embodiments, when the CU determines to configure the UE with L1/L2 inter-cell mobility candidate cells from the serving DU and from at least one neighbor DU, the CU requests and obtains the configurations from the neighbor DUs before requesting the configurations from the serving DU. This ordering enables the CU to send the CSI resource configurations for L1/L2 inter-cell mobility candidates of the neighbor DU in the request (e.g., UE CONTEXT MODIFICATION REQUEST) for the serving DU to configure L1/L2 inter-cell mobility candidates.

In response to the request in operation 2a, the serving DU generates the CSI resource configuration per L1/L2 inter-cell mobility candidate cell that it provides, which it includes the response of operation 2b. In some embodiments, the response also includes the CSI resource configuration per L1/L2 inter-cell mobility candidate cell provided by neighbor DUs, according to various embodiments described above.

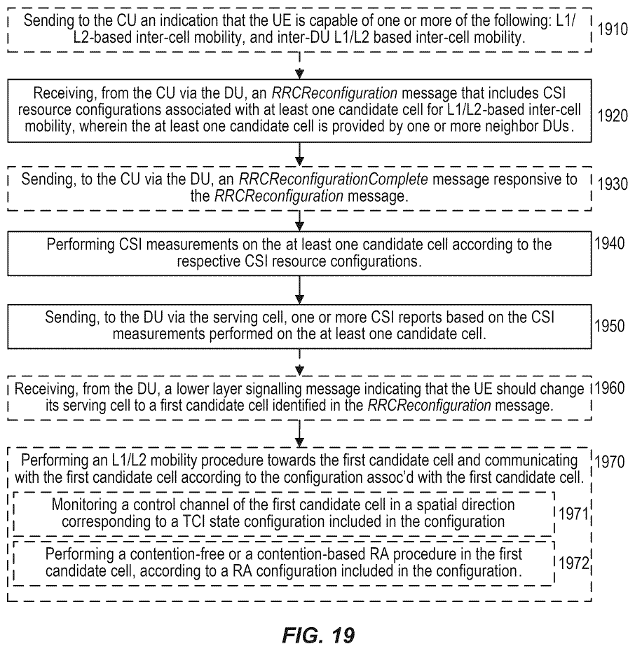

The embodiments described above can be further illustrated with reference to FIGS. 19-22, which depict exemplary methods (e.g., procedures) for a UE, a CU, a first DU, and a second DU, respectively. Put differently, various features of the operations described below correspond to various embodiments described above. The exemplary methods shown in FIGS. 10-12 can be used cooperatively to provide benefits, advantages, and/or solutions to problems described herein. Although the exemplary methods are illustrated in FIGS. 10-12 by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 19 illustrates an exemplary method (e.g., procedure) for a UE configured to communicate with a RAN node comprising a CU and a DU, according to various embodiments of the present disclosure. The exemplary method shown in FIG. 19 can be performed by a UE (e.g., wireless device) such as described elsewhere herein.

The exemplary method can include the operations of block 1920, where the UE can receive, from the CU via the DU, an RRCReconfiguration message that includes channel state information (CSI) resource configurations associated with each of at least one candidate cell for L1/L2-based inter-cell mobility. The at least one candidate cell is provided by one or more neighbor DUs. In some embodiments, the one or more neighbor DUs are associated with the CU and/or are part of the RAN node.

The exemplary method can also include the operations of block 1940, where the UE can perform CSI measurements on the at least one candidate cell according to the respective CSI resource configurations. The exemplary method can also include the operations of block 1950, where the UE can send, to the DU via the serving cell, one or more CSI reports based on the CSI measurements performed on the at least one candidate cell.

In some embodiments, the RRCReconfiguration message also includes configurations associated with the at least one candidate cell and the exemplary method also includes the following operations, labelled with corresponding block numbers:
(1960) receiving from the DU a lower layer signalling message indicating that the UE should change its serving cell to a first candidate cell identified in the RRCReconfiguration message, and
(1970) performing an L1/L2 mobility procedure towards the first candidate cell and communicating in the first candidate cell according to the configuration associated with the first candidate cell.

In some of these embodiments, one or more of the following applies: the lower layer signaling is at a protocol layer below the RRC protocol layer; and the lower layer signaling includes one of the following: MAC CE, or PHY Downlink Control Information (DCI).

In some of these embodiments, communicating in the first candidate cell according to the configuration in block 1970 includes one or more of the following operations, labelled with corresponding sub-block numbers:
(1971) monitoring a control channel of the first candidate cell in a spatial direction corresponding to a Transmission Configuration Information (TCI) state configuration included in the configuration; and\
(1972) performing a contention-free or a contention-based random access (RA) procedure in the first candidate cell, according to a RA configuration included in the configuration.

In some embodiments, the RRCReconfiguration message includes one or more reporting configurations associated with the respective CSI resource configurations and the CSI reports are sent based on the one or more reporting configurations. In some of these embodiments, each reporting configuration includes one of more of the following:
configuration of physical channels used for sending CSI reports;
indication of one or more quantities or metrics to be reported; and
one or more conditions that trigger sending CSI reports.

In some embodiments, the exemplary method can also include the operations of block 1930, where the UE can send, to the CU via the DU, an RRCReconfigurationComplete message responsive to the RRCReconfiguration message. In some embodiments, each CSI resource configuration includes one or more of the following:
a resource configuration identifier;
identification of one or more reference signals (RS) to be transmitted by the candidate cell and measured by the UE;
an identifier of a bandwidth part in which the identified RS will be transmitted;
a type associated with the identified RS; and
an indication of the candidate cell associated with the identified RS.

In some of these embodiments, the RRCReconfiguration message includes a plurality of CSI resource configurations arranged according to one or more of the following:
multiple sets of CSI resources associated with a single candidate cell;
multiple candidate cells associated with respective single sets of CSI resources; and
multiple candidate cells associated with respective multiple sets of CSI resources.

In some of these embodiments, the RS are identified by indices of beams that are transmitted in different spatial directions.

In some embodiments, a first set of conditions or a second set of conditions applies to the RRCReconfiguration message. The first set of conditions includes one or more of the following:
the RRCReconfiguration message is received during the UE's initial access to the serving DU; and
the RRCReconfiguration message is an initial RRCReconfiguration message received after security is activated during the UE's initial access.

Also, the second set of conditions includes one or more of the following:
the RRCReconfiguration message is received when the UE is in RRC_CONNECTED state with the RAN; and
the RRCReconfiguration message is received in response to an RRC Measurement Report sent by the UE.

In some embodiments, the exemplary method can also include the operations of block 1910, where the UE can send to the CU an indication that the UE is capable of one or more of the following: L1/L2-based inter-cell mobility, and inter-DU L1/L2 based inter-cell mobility.

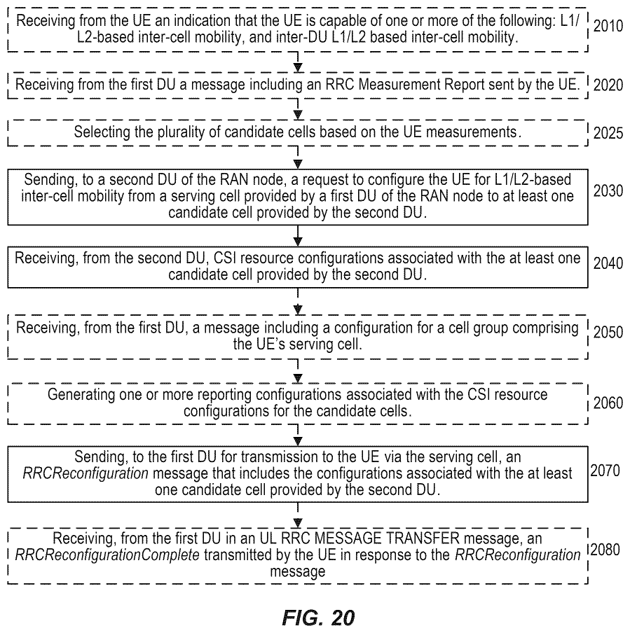

In addition, FIG. 20 illustrates an exemplary method (e.g., procedure) for a CU of a RAN node, according to various embodiments of the present disclosure. The exemplary method shown in FIG. 20 can be performed by a CU such as described elsewhere herein.

The exemplary method includes the operations of block 2030, where the CU can send, to a second DU of the RAN node, a request to configure a UE for L1/L2-based inter-cell mobility from a serving cell provided by a first DU of the RAN node to at least one candidate cell provided by the second DU. The exemplary method also includes the operations of block 2040, where the CU can receive, from the second DU, a response including CSI resource configurations associated with the at least one candidate cell provided by the second DU. The exemplary method also includes the operations of block 2070, where the CU can send, to the first DU for transmission to the UE vis the serving cell, an RRCReconfiguration message that includes CSI resource configurations associated with the at least one candidate cell provided by the second DU.

In some embodiments, the response also includes configurations associated with each of the at least one candidate cells and the RRCReconfiguration message also includes the configurations associated with each of the at least one candidate cells.

In some embodiments, the exemplary method can also include the operations of blocks 2080, where the CU can receive, from the first DU, an RRCReconfigurationComplete transmitted by the UE in response to the RRCReconfiguration message.

In some embodiments, the second DU is associated with the CU and/or is part of the RAN node. In some of these embodiments, the RRCReconfiguration message is sent to the first DU in a DL RRC MESSAGE TRANSFER message.

In some embodiments, the second DU is a neighbor DU that does not provide the UE's serving cell; the request to configure the UE is, or is included in, a UE CONTEXT SETUP REQUEST message; and the response is, or is included in, a UE CONTEXT SETUP RESPONSE message. In some of these embodiments, the exemplary method can also include the operations of block 2080, where the CU can receive, from the first DU in an UL RRC MESSAGE TRANSFER message, an RRCReconfigurationComplete transmitted by the UE in response to the RRCReconfiguration message. Also, the RRCReconfiguration message is sent to the first DU in block 2070 in a DL RRC MESSAGE TRANSFER message.

In some embodiments, the exemplary method can also include the operations of block 2020, where the CU can receive from the first DU a message comprising an RRC Measurement Report sent by the UE. The request to configure the UE for L1/L2-based inter-cell mobility is sent (e.g., in block 2030) in response to the message comprising the RRC Measurement Report.

In some of these embodiments, the RRC Measurement Report includes one or more UE measurements of the at least one candidate cell provided by the second DU. In some variants of these embodiments, the at least one candidate cell includes a plurality of candidate cells and the exemplary method also includes the operations of block 2025, where the CU can select the plurality of candidate cells based on the UE measurements. In such case, the request sent to the second DU in block 2030 comprises respective identifiers of the plurality of candidate cells.

In some embodiments, each CSI resource configuration includes one or more of the following:
a resource configuration identifier;
identification of one or more RS to be transmitted by the candidate cell and measured by the UE;
an identifier of a bandwidth part in which the identified RS will be transmitted;
a type associated with the identified RS; and
an indication of the candidate cell associated with the identified RS.

In some embodiments, the RRCReconfiguration message includes a plurality of CSI resource configurations arranged according to one or more of the following:
multiple sets of CSI resources associated with a single candidate cell;
multiple candidate cells associated with respective single sets of CSI resources;
multiple candidate cells associated with respective multiple sets of CSI resources.

In some embodiments, the RRCReconfiguration message includes one or more reporting configurations associated with the respective CSI resource configurations for the candidate cells and each reporting configuration includes one or more of the following:
configuration of physical channels used for sending CSI reports;
indication of one or more quantities or metrics to be reported; and
one or more conditions that trigger sending CSI reports.

In some of these embodiments, the exemplary method can also include the operations of block 2050, where the CU can receive, from the first DU, a message including a configuration for a cell group comprising the UE's serving cell. In such embodiments, the one or more reporting configurations are received in the message as separated from the configuration for the cell group.

In other of these embodiments, the exemplary method can also include the operations of block 2060, where the CU can generate the one or more reporting configurations. In such embodiments, the one or more reporting configurations are included in the RRCReconfiguration message as separated from a configuration for a cell group comprising the UE's serving cell.

In some embodiments, the exemplary method can also include the operations of block 2010, where the CU can receive from the UE an indication that the UE is capable of one or more of the following: L1/L2-based inter-cell mobility, and inter-DU L1/L2 based inter-cell mobility. In such embodiments, sending the request to configure the UE (e.g., in block 2030) is based on the indication received from the UE.

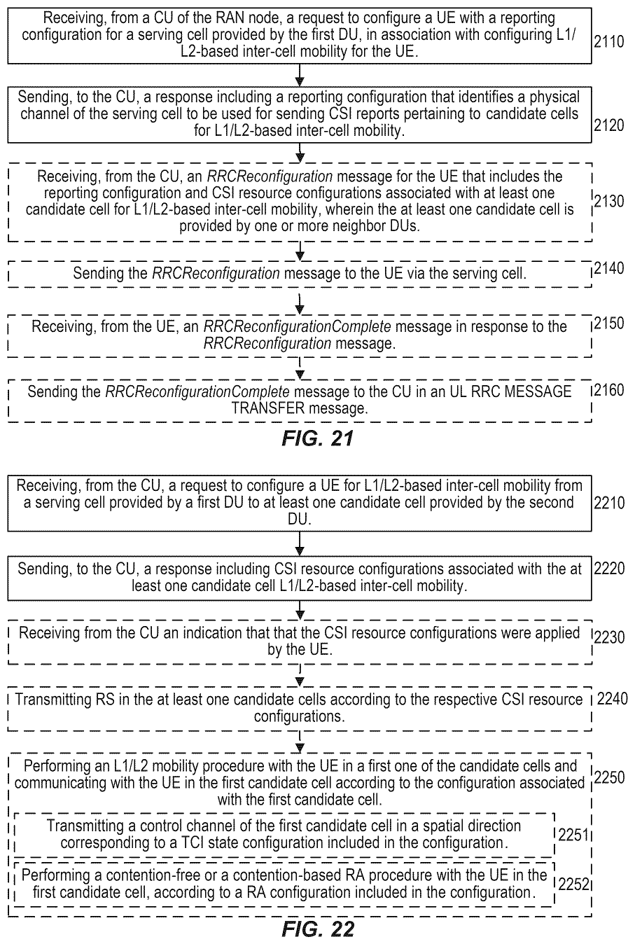

In addition, FIG. 21 illustrates an exemplary method (e.g., procedure) for a first DU of a RAN node, according to various embodiments of the present disclosure. The exemplary method shown in FIG. 21 can be performed by serving DU such as described elsewhere herein.

The exemplary method can include the operations of block 2120, where the first DU can receive, from a CU of the RAN node, a request to configure a UE with a reporting configuration for a serving cell provided by the first DU, in association with configuring L1/L2-based inter-cell mobility for the UE. The exemplary method can also include the operations of block 2120, where the first DU can send, to the CU, a response including a reporting configuration that identifies a physical channel of the serving cell to be used for sending CSI reports pertaining to candidate cells for L1/L2-based inter-cell mobility.

In some embodiments, the reporting configuration includes one or more of the following:
configuration of physical channels used for sending CSI reports;
indication of one or more quantities or metrics to be reported; and
one or more conditions that trigger sending CSI reports.

In some embodiments, the response also includes CSI resource configurations associated with at least one candidate cell for L1/L2-based inter-cell mobility, with the at least one candidate cell being provided by the first DU. In some of these embodiments, each CSI resource configuration includes one or more of the following:
a resource configuration identifier;
identification of one or more RS to be transmitted by the candidate cell and measured by the UE;
an identifier of a bandwidth part in which the identified RS will be transmitted;
a type associated with the identified RS; and
an indication of the candidate cell associated with the identified RS.

In some of these embodiments, the response includes a configuration for a cell group comprising the UE's serving cell, and one of the following applies:
the reporting configuration is included within the configuration for the cell group, or
the reporting configuration is included in the response as separated from the configuration for the cell group.

In some embodiments, the exemplary method can also include the following operations, labelled with corresponding block numbers:
(2130) receiving from the CU an RRCReconfiguration message for the UE that includes the reporting configuration and CSI resource configurations associated with at least one candidate cell for L1/L2-based inter-cell mobility, wherein the at least one candidate cell is provided by one or more neighbor DUs; and
(2140) sending the RRCReconfiguration message to the UE via the serving cell.

In some of these embodiments, the RRCReconfiguration message is received from the CU in a DL RRC MESSAGE TRANSFER message and the exemplary method also includes the following operations, labelled with corresponding block numbers:
(2150) receiving from the UE an RRCReconfigurationComplete message in response to the RRCReconfiguration message, and
(2160) sending the RRCReconfigurationComplete message to the CU in an UL RRC MESSAGE TRANSFER message.

In addition, FIG. 22 illustrates an exemplary method (e.g., procedure) for a second DU of a RAN node, according to various embodiments of the present disclosure. The exemplary method shown in FIG. 22 can be performed by a candidate (e.g., neighbor or serving) DU such as described elsewhere herein.

The exemplary method can include the operations of block 2210, where the second DU can receive, from a CU of the RAN node, a request to configure a UE for L1/L2-based inter-cell mobility from a serving cell provided by a first DU of the RAN node to at least one candidate cell provided by the second DU. The exemplary method can include the operations of block 2220, where the second DU can send, to the CU, a response including CSI resource configurations associated with the at least one candidate cell L1/L2-based inter-cell mobility.

In some embodiments, the response also includes configurations associated with each of the at least one candidate cells and the exemplary method also includes the operations of block 2250, where the second DU can perform an L1/L2 mobility procedure with the UE in a first one of the candidate cells and communicate with the UE in the first candidate cell according to the configuration associated with the first candidate cell. In some of these embodiments, communicating with the UE in the first candidate cell according to the configuration in block 2250 includes one or more of the following, labelled with corresponding sub-block numbers:
(2251) transmitting a control channel of the first candidate cell in a spatial direction corresponding to a TCI state configuration included in the configuration; and
(2252) performing a contention-free or a contention-based RA procedure with the UE in the first candidate cell, according to a RA configuration included in the configuration.

In some of these embodiments, the second DU is a neighbor DU that does not provide the UE's serving cell; the request to configure the UE is, or is included in, a UE CONTEXT SETUP REQUEST message; and the response is, or is included in, a UE CONTEXT SETUP RESPONSE message.

In some embodiments, each CSI resource configuration includes one or more of the following:
a resource configuration identifier;
identification of one or more RS to be transmitted by the candidate cell and measured by the UE;
an identifier of a bandwidth part in which the identified RS will be transmitted;
a type associated with the identified RS; and
an indication of the candidate cell associated with the identified RS.
   In some of these embodiments, the response includes a plurality of CSI resource configurations arranged according to one or more of the following:
multiple sets of CSI resources associated with a single candidate cell;
multiple candidate cells associated with respective single sets of CSI resources;
multiple candidate cells associated with respective multiple sets of CSI resources.
   In some of these embodiments, the RS are identified by indices of beams that are transmitted in different spatial directions.

In some embodiments, the exemplary method can also include the operations of block 2240, where the second DU can transmit RS in the at least one candidate cell according to the respective CSI resource configurations. In some of these embodiments, the exemplary method can also include the operations of block 2230, where the second DU can receive from the CU an indication that that the CSI resource configurations were applied by the UE. In such case, transmitting the RS in block 2240 is responsive to the indication.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

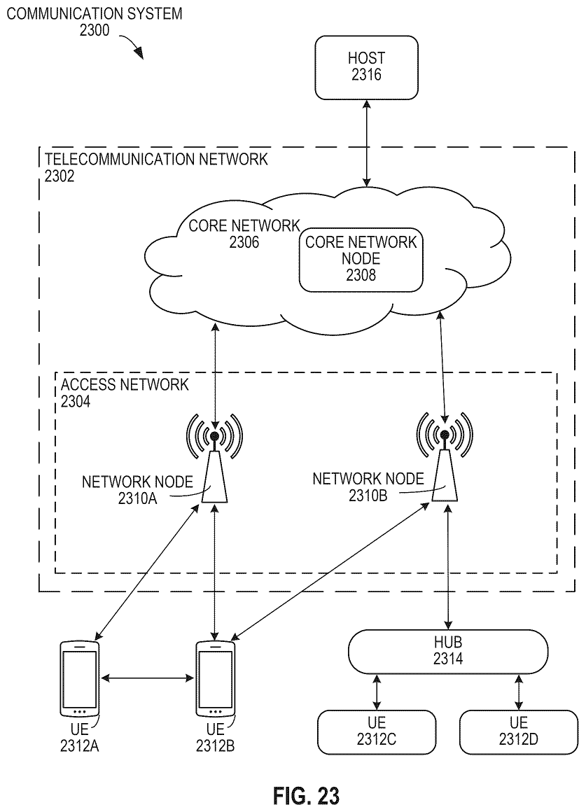

FIG. 23 shows an example of a communication system 2300 in accordance with some embodiments. In this example, communication system 2300 includes a telecommunication network 2302 that includes an access network 2304 (e.g., RAN) and a core network 2306, which includes one or more core network nodes 2308. Access network 2304 includes one or more access network nodes, such as network nodes 2310a-b (one or more of which may be generally referred to as network nodes 2310), or any other similar 3GPP access node or non-3GPP access point. Network nodes 2310 facilitate direct or indirect connection UEs, such as by connecting UEs 2312a-d (one or more of which may be generally referred to as UEs 2312) to core network 2306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 2300 may include any number of wired or wireless networks, network nodes, UEs, and/or any other components or systems that may facilitate or participate in the communication of data and/or signals whether via wired or wireless connections. Communication system 2300 may include and/or interface with any type of communication, telecommunication, data, cellular, radio network, and/or other similar type of system.

UEs 2312 may be any of a wide variety of communication devices, including wireless devices arranged, configured, and/or operable to communicate wirelessly with network nodes 2310 and other communication devices. Similarly, network nodes 2310 are arranged, capable, configured, and/or operable to communicate directly or indirectly with UEs 2312 and/or with other network nodes or equipment in telecommunication network 2302 to enable and/or provide network access, such as wireless network access, and/or to perform other functions, such as administration in telecommunication network 2302.

In the depicted example, core network 2306 connects network nodes 2310 to one or more hosts, such as host 2316. These connections may be direct or indirect via one or more intermediary networks or devices. In other examples, network nodes may be directly coupled to hosts. Core network 2306 includes one or more core network nodes (e.g., 2308) that are structured with hardware and software components. Features of these components may be substantially similar to those described with respect to the UEs, network nodes, and/or hosts, such that the descriptions thereof are generally applicable to the corresponding components of core network node 2308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 2316 may be under the ownership or control of a service provider other than an operator or provider of access network 2304 and/or telecommunication network 2302, and may be operated by the service provider or on behalf of the service provider. Host 2316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 2300 of FIG. 23 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 2302 is a cellular network that implements 3GPP standardized features. Accordingly, telecommunication network 2302 may support network slicing to provide different logical networks to different devices that are connected to telecommunication network 2302. For example, telecommunication network 2302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 2312 are configured to transmit and/or receive information without direct human interaction. For instance, a UE may be designed to transmit information to access network 2304 on a predetermined schedule, when triggered by an internal or external event, or in response to requests from access network 2304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 2314 communicates with access network 2304 to facilitate indirect communication between one or more UEs (e.g., UE 2312c and/or 2312d) and network nodes (e.g., network node 2310b). In some examples, hub 2314 may be a controller, router, content source and analytics, or any of the other communication devices described herein regarding UEs. For example, hub 2314 may be a broadband router enabling access to core network 2306 for the UEs. As another example, hub 2314 may be a controller that sends commands or instructions to one or more actuators in the UEs. Commands or instructions may be received from the UEs, network nodes 2310, or by executable code, script, process, or other instructions in hub 2314. As another example, bub 2314 may be a data collector that acts as temporary storage for UE data and, in some embodiments, may perform analysis or other processing of the data. As another example, hub 2314 may be a content source. For example, for a UE that is a VR headset, display, loudspeaker or other media delivery device, hub 2314 may retrieve VR assets, video, audio, or other media or data related to sensory information via a network node, which hub 2314 then provides to the UE either directly, after performing local processing, and/or after adding additional local content. In still another example, hub 2314 acts as a proxy server or orchestrator for the UEs, in particular in if one or more of the UEs are low energy IoT devices.

Hub 2314 may have a constant/persistent or intermittent connection to the network node 2310b. Hub 2314 may also allow for a different communication scheme and/or schedule between hub 2314 and UEs (e.g., UE 2312c and/or 2312d), and between hub 2314 and core network 2306. In other examples, hub 2314 is connected to core network 2306 and/or one or more UEs via a wired connection. Moreover, hub 2314 may be configured to connect to an M2M service provider over access network 2304 and/or to another UE over a direct connection. In some scenarios, UEs may establish a wireless connection with network nodes 2310 while still connected via hub 2314 via a wired or wireless connection. In some embodiments, hub 2314 may be a dedicated hub—that is, a hub whose primary function is to route communications to/from the UEs from/to the network node 2310b. In other embodiments, hub 2314 may be a non-dedicated hub—that is, a device which is capable of operating to route communications between the UEs and network node 2310b, but which is additionally capable of operating as a communication start and/or end point for certain data channels.

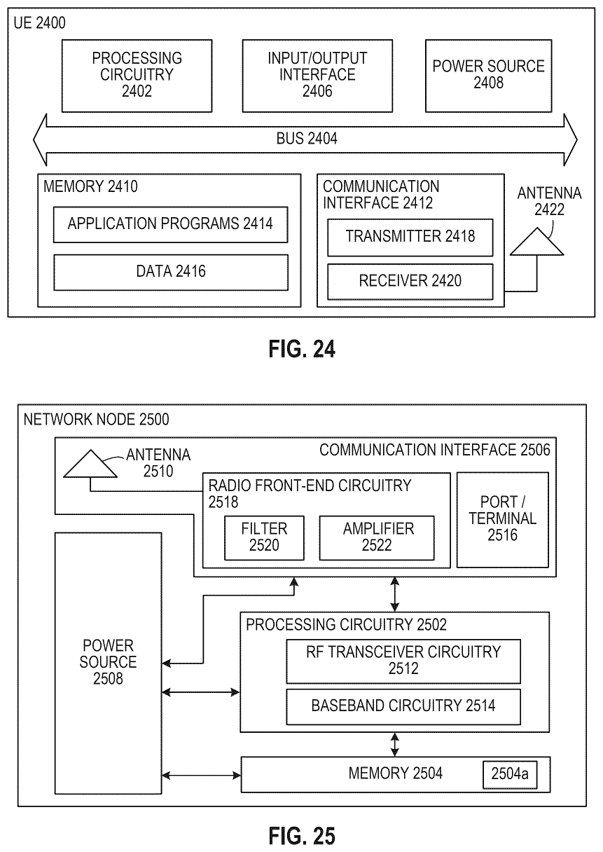

FIG. 24 shows a UE 2400 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 2400 includes processing circuitry 2402 that is operatively coupled via a bus 2404 to an input/output interface 2406, a power source 2408, a memory 2410, a communication interface 2412, and/or any other component, or any combination thereof. Certain UEs may utilize all or a subset of the components shown in FIG. 24. The level of integration between the components may vary from one UE to another UE. Further, certain UEs may contain multiple instances of a component, such as multiple processors, memories, transceivers, transmitters, receivers, etc.

Processing circuitry 2402 is configured to process instructions and data and may be configured to implement any sequential state machine operative to execute instructions stored as machine-readable computer programs in memory 2410. Processing circuitry 2402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 2402 may include multiple central processing units (CPUs).

In the example, input/output interface 2406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 2400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 2408 is structured as a battery or battery pack. Other types of power sources, such as an external power source (e.g., an electricity outlet), photovoltaic device, or power cell, may be used. Power source 2408 may further include power circuitry for delivering power from power source 2408 itself, and/or an external power source, to the various parts of UE 2400 via input circuitry or an interface such as an electrical power cable. Delivering power may be, for example, for charging power source 2408. Power circuitry may perform any formatting, converting, or other modification to the power from power source 2408 to make the power suitable for the respective components of UE 2400 to which power is supplied.

Memory 2410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 2410 includes one or more application programs 2414, such as an operating system, web browser application, a widget, gadget engine, or other application, and corresponding data 2416. Memory 2410 may store, for use by UE 2400, any of a variety of various operating systems or combinations of operating systems.

Memory 2410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 2410 may allow UE 2400 to access instructions, application programs and the like, stored on transitory or non-transitory memory media, to off-load data, or to upload data. An article of manufacture, such as one utilizing a communication system may be tangibly embodied as or in memory 2410, which may be or comprise a device-readable storage medium.

Processing circuitry 2402 may be configured to communicate with an access network or other network using communication interface 2412. Communication interface 2412 may comprise one or more communication subsystems and may include or be communicatively coupled to an antenna 2422. Communication interface 2412 may include one or more transceivers used to communicate, such as by communicating with one or more remote transceivers of another device capable of wireless communication (e.g., another UE or a network node in an access network). Each transceiver may include transmitter 2418 and/or receiver 2420 appropriate to provide network communications (e.g., optical, electrical, frequency allocations, and so forth). Moreover, transmitter 2418 and receiver 2420 may be coupled to one or more antennas (e.g., 2422) and may share circuit components, software or firmware, or alternatively be implemented separately.

In the illustrated embodiment, communication functions of communication interface 2412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 2400 shown in FIG. 24.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 25 shows a network node 2500 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved serving Mobile Location Centers (E-SMLCs)), and/or Minimization of Drive Tests (MDTs).

Network node 2500 includes processing circuitry 2502, memory 2504, communication interface 2506, and power source 2508. Network node 2500 may be composed of multiple physically separate components (e.g., a NodeB component and a RNC component, or a BTS component and a BSC component, etc.), which may each have their own respective components. In certain scenarios in which network node 2500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 2500 may be configured to support multiple radio access technologies (RATs). In such embodiments, some components may be duplicated (e.g., separate memory 2504 for different RATs) and some components may be reused (e.g., a same antenna 2510 may be shared by different RATs). Network node 2500 may also include multiple sets of the various illustrated components for different wireless technologies integrated into network node 2500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2500.

Processing circuitry 2502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2500 components, such as memory 2504, to provide network node 2500 functionality.

In some embodiments, processing circuitry 2502 includes a system on a chip (SOC). In some embodiments, processing circuitry 2502 includes radio frequency (RF) transceiver circuitry 2512 and/or baseband processing circuitry 2514. In some embodiments, RF transceiver circuitry 2512 and baseband processing circuitry 2514 may be on separate chips (or sets of chips), boards, or units, such as radio units and digital units. In alternative embodiments, part or all of RF transceiver circuitry 2512 and baseband processing circuitry 2514 may be on the same chip or set of chips, boards, or units.

Memory 2504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 2502. Memory 2504 may store any suitable instructions, data, or information, including a computer program, software, an application including one or more of logic, rules, code, tables, and/or other instructions (collectively denoted computer program 2504a, which may be in the form of a computer program product) capable of being executed by processing circuitry 2502 and utilized by network node 2500. Memory 2504 may be used to store any calculations made by processing circuitry 2502 and/or any data received via communication interface 2506. In some embodiments, processing circuitry 2502 and memory 2504 is integrated.

Communication interface 2506 is used in wired or wireless communication of signaling and/or data between a network node, access network, and/or UE. As illustrated, communication interface 2506 comprises port(s)/terminal(s) 2516 to send and receive data, for example to and from a network over a wired connection. Communication interface 2506 also includes radio front-end circuitry 2518 that may be coupled to, or in certain embodiments a part of, antenna 2510. Radio front-end circuitry 2518 comprises filters 2520 and amplifiers 2522. Radio front-end circuitry 2518 may be connected to an antenna 2510 and processing circuitry 2502. Radio front-end circuitry 2518 may be configured to condition signals communicated between antenna 2510 and processing circuitry 2502. Radio front-end circuitry 2518 may receive digital data that is to be sent out to other network nodes or UEs via a wireless connection. Radio front-end circuitry 2518 may convert the digital data into a radio signal having the appropriate channel and bandwidth parameters using a combination of filters 2520 and/or amplifiers 2522. The radio signal may then be transmitted via antenna 2510. Similarly, when receiving data, antenna 2510 may collect radio signals which are then converted into digital data by radio front-end circuitry 2518. The digital data may be passed to processing circuitry 2502. In other embodiments, the communication interface may comprise different components and/or different combinations of components.

In certain alternative embodiments, network node 2500 does not include separate radio front-end circuitry 2518, instead, processing circuitry 2502 includes radio front-end circuitry and is connected to antenna 2510. Similarly, in some embodiments, all or some of RF transceiver circuitry 2512 is part of communication interface 2506. In still other embodiments, communication interface 2506 includes one or more ports or terminals 2516, radio front-end circuitry 2518, and RF transceiver circuitry 2512, as part of a radio unit (not shown), and communication interface 2506 communicates with baseband processing circuitry 2514, which is part of a digital unit (not shown).

Antenna 2510 may include one or more antennas, or antenna arrays, configured to send and/or receive wireless signals. Antenna 2510 may be coupled to radio front-end circuitry 2518 and may be any type of antenna capable of transmitting and receiving data and/or signals wirelessly. In certain embodiments, antenna 2510 is separate from network node 2500 and connectable to network node 2500 through an interface or port.

Antenna 2510, communication interface 2506, and/or processing circuitry 2502 may be configured to perform any receiving operations and/or certain obtaining operations described herein as being performed by the network node. Any information, data and/or signals may be received from a UE, another network node and/or any other network equipment. Similarly, antenna 2510, communication interface 2506, and/or processing circuitry 2502 may be configured to perform any transmitting operations described herein as being performed by the network node. Any information, data and/or signals may be transmitted to a UE, another network node and/or any other network equipment.

Power source 2508 provides power to the various components of network node 2500 in a form suitable for the respective components (e.g., at a voltage and current level needed for each respective component). Power source 2508 may further comprise, or be coupled to, power management circuitry to supply the components of network node 2500 with power for performing the functionality described herein. For example, network node 2500 may be connectable to an external power source (e.g., the power grid, an electricity outlet) via an input circuitry or interface such as an electrical cable, whereby the external power source supplies power to power circuitry of power source 2508. As a further example, power source 2508 may comprise a source of power in the form of a battery or battery pack which is connected to, or integrated in, power circuitry. The battery may provide backup power should the external power source fail.

Embodiments of network node 2500 may include additional components beyond those shown in FIG. 25 for providing certain aspects of the network node's functionality, including any of the functionality described herein and/or any functionality necessary to support the subject matter described herein. For example, network node 2500 may include user interface equipment to allow input of information into network node 2500 and to allow output of information from network node 2500. This may allow a user to perform diagnostic, maintenance, repair, and other administrative functions for network node 2500.

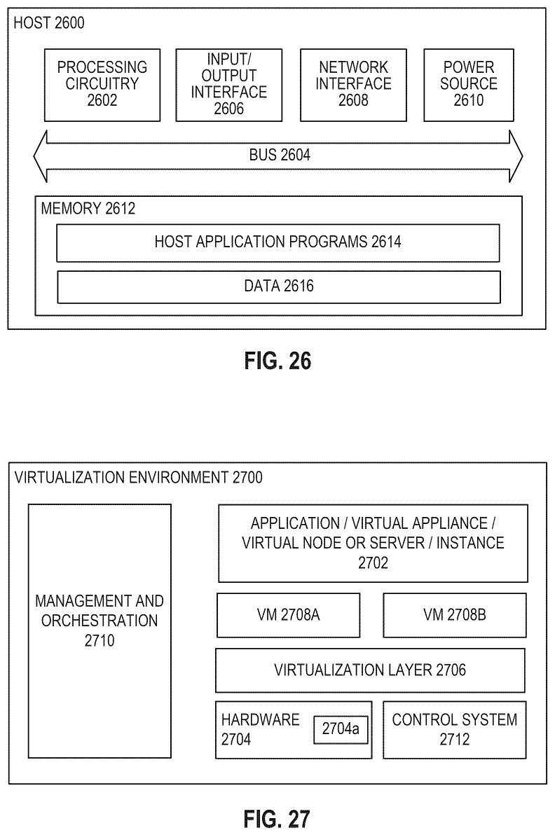

FIG. 26 is a block diagram of a host 2600, which may be an embodiment of host 2316 of FIG. 23, in accordance with various aspects described herein. As used herein, host 2600 may be or comprise various combinations hardware and/or software, including a standalone server, a blade server, a cloud-implemented server, a distributed server, a virtual machine, container, or processing resources in a server farm. Host 2600 may provide one or more services to one or more UEs.

Host 2600 includes processing circuitry 2602 that is operatively coupled via a bus 2604 to an input/output interface 2606, a network interface 2608, a power source 2610, and a memory 2612. Other components may be included in other embodiments. Features of these components may be substantially similar to those described with respect to the devices of previous figures, such as FIGS. 24 and 25, such that the descriptions thereof are generally applicable to the corresponding components of host 2600.

Memory 2612 may include one or more computer programs including one or more host application programs 2614 and data 2616, which may include user data, e.g., data generated by a UE for host 2600 or data generated by host 2600 for a UE. Embodiments of host 2600 may utilize only a subset or all of the components shown. Host application programs 2614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2614 may also provide for user authentication and licensing checks and may periodically report health, routes, and content availability to a central node, such as a device in or on the edge of a core network. Accordingly, host 2600 may select and/or indicate a different host for over-the-top services for a UE. Host application programs 2614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 27 is a block diagram illustrating a virtualization environment 2700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2702 (which may alternatively be called software instances, virtual appliances, network functions, virtual nodes, virtual network functions, etc.) are run in virtualization environment 2700 to implement some of the features, functions, and/or benefits of some of the embodiments disclosed herein.

Hardware 2704 includes processing circuitry, memory that stores software and/or instructions (collectively denoted computer program 2704ₐ, which may be in the form of a computer program product) executable by hardware processing circuitry, and/or other hardware devices as described herein, such as a network interface, input/output interface, and so forth. Software may be executed by the processing circuitry to instantiate one or more virtualization layers 2706 (also referred to as hypervisors or virtual machine monitors (VMMs)), provide VMs 2708a-b (one or more of which may be generally referred to as VMs 2708), and/or perform any of the functions, features and/or benefits described in relation with some embodiments described herein. Virtualization layer 2706 may present a virtual operating platform that appears like networking hardware to the VMs 2708.

The VMs 2708 comprise virtual processing, virtual memory, virtual networking or interface and virtual storage, and may be run by a corresponding virtualization layer 2706. Different embodiments of the instance of a virtual appliance 2702 may be implemented on one or more of VMs 2708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2708 may be a software implementation of a physical machine that runs programs as if they were executing on a physical, non-virtualized machine. Each VM 2708, and that part of hardware 2704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2708 on top of the hardware 2704 and corresponds to application 2702.

Hardware 2704 may be implemented in a standalone network node with generic or specific components. Hardware 2704 may implement some functions via virtualization. Alternatively, hardware 2704 may be part of a larger cluster of hardware (e.g., such as in a data center or CPE) where many hardware nodes work together and are managed via management and orchestration 2710, which, among others, oversees lifecycle management of applications 2702. In some embodiments, hardware 2704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2712 which may alternatively be used for communication between hardware nodes and radio units.

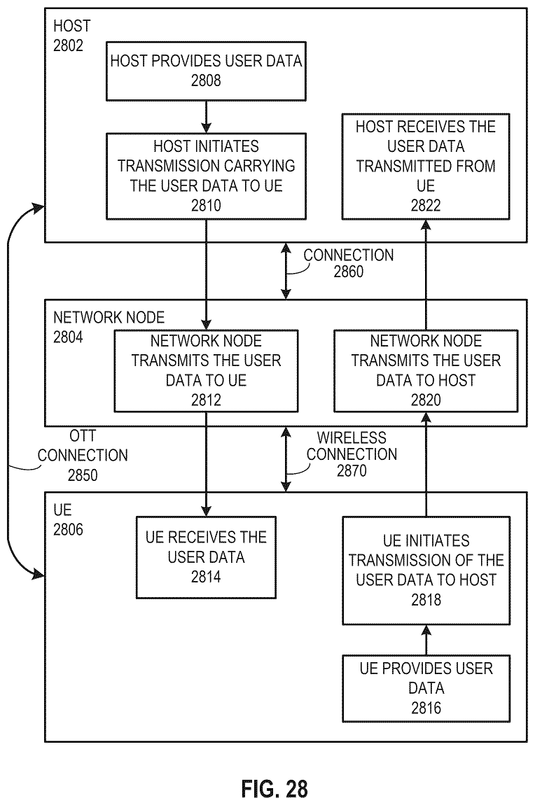

FIG. 28 shows a communication diagram of a host 2802 communicating via a network node 2804 with a UE 2806 over a partially wireless connection in accordance with some embodiments. Example implementations, in accordance with various embodiments, of the UE (such as a UE 2312a of FIG. 23 and/or UE 2400 of FIG. 24), network node (such as network node 2310a of FIG. 23 and/or network node 2500 of FIG. 25), and host (such as host 2316 of FIG. 23 and/or host 2600 of FIG. 26) discussed in the preceding paragraphs will now be described with reference to FIG. 28.

Like host 2600, embodiments of host 2802 include hardware, such as a communication interface, processing circuitry, and memory. Host 2802 also includes software, which is stored in or accessible by host 2802 and executable by the processing circuitry. The software includes a bost application that may be operable to provide a service to a remote user, such as UE 2806 connecting via an over-the-top (OTT) connection 2850 extending between UE 2806 and host 2802. In providing the service to the remote user, a host application may provide user data which is transmitted using OTT connection 2850.

Network node 2804 includes hardware enabling it to communicate with bost 2802 and UE 2806. Connection 2860 may be direct or pass through a core network (like core network 2306 of FIG. 23) and/or one or more other intermediate networks, such as one or more public, private, or hosted networks. For example, an intermediate network may be a backbone network or the Internet.

UE 2806 includes hardware and software, which is stored in or accessible by UE 2806 and executable by the UE's processing circuitry. The software includes a client application, such as a web browser or operator-specific “app” that may be operable to provide a service to a human or non-human user via UE 2806 with the support of host 2802. In host 2802, an executing host application may communicate with the executing client application via OTT connection 2850 terminating at UE 2806 and host 2802. In providing the service to the user, the UE's client application may receive request data from the host's host application and provide user data in response to the request data. OTT connection 2850 may transfer both the request data and the user data. The UE's client application may interact with the user to generate the user data that it provides to the host application through OTT connection 2850.

OTT connection 2850 may extend via a connection 2860 between host 2802 and network node 2804 and via a wireless connection 2870 between network node 2804 and UE 2806 to provide the connection between host 2802 and UE 2806. Connection 2860 and wireless connection 2870, over which OTT connection 2850 may be provided, have been drawn abstractly to illustrate the communication between host 2802 and UE 2806 via network node 2804, without explicit reference to any intermediary devices and the precise routing of messages via these devices.

As an example of transmitting data via OTT connection 2850, in step 2808, host 2802 provides user data, which may be performed by executing a host application. In some embodiments, the user data is associated with a particular human user interacting with UE 2806. In other embodiments, the user data is associated with a UE 2806 that shares data with host 2802 without explicit human interaction. In step 2810, host 2802 initiates a transmission carrying the user data towards UE 2806. Host 2802 may initiate the transmission responsive to a request transmitted by UE 2806. The request may be caused by human interaction with UE 2806 or by operation of the client application executing on UE 2806. The transmission may pass via network node 2804, in accordance with the teachings of the embodiments described throughout this disclosure. Accordingly, in step 2812, network node 2804 transmits to UE 2806 the user data that was carried in the transmission that host 2802 initiated, in accordance with the teachings of the embodiments described throughout this disclosure. In step 2814, UE 2806 receives the user data carried in the transmission, which may be performed by a client application executed on UE 2806 associated with the host application executed by host 2802.

In some examples, UE 2806 executes a client application which provides user data to host 2802. The user data may be provided in reaction or response to the data received from host 2802. Accordingly, in step 2816, UE 2806 may provide user data, which may be performed by executing the client application. In providing the user data, the client application may further consider user input received from the user via an input/output interface of UE 2806. Regardless of the specific manner in which the user data was provided, UE 2806 initiates, in step 2818, transmission of the user data towards host 2802 via network node 2804. In step 2820, in accordance with the teachings of the embodiments described throughout this disclosure, network node 2804 receives user data from UE 2806 and initiates transmission of the received user data towards host 2802. In step 2822, host 2802 receives the user data carried in the transmission initiated by UE 2806.

One or more of the various embodiments improve the performance of OTT services provided to UE 2806 using OTT connection 2850, in which wireless connection 2870 forms the last segment. For example, embodiments can facilitate configuring a UE with CSI measurement resources for one or more L1/L2 inter-cell mobility candidate cells associated with a neighbor DU, on which the UE can perform and report mobility measurements to the network. These CSI reports facilitate L1/L2 inter-cell mobility decisions by the network, which enables the UE to move further in its coverage area. This promotes more efficient signaling, reduced processing, and reduced interruption time compared to an L3 (e.g., RRC) handover. Embodiments also maintain L1/L2 mobility interoperability between the UE, the serving DU/CU, and the neighbor DU without ambiguities. By improving operation of UEs and RANs in this manner, embodiments increase the value of OTT services delivered to/from the UE via the RAN.

In an example scenario, factory status information may be collected and analyzed by host 2802. As another example, host 2802 may process audio and video data which may have been retrieved from a UE for use in creating maps. As another example, host 2802 may collect and analyze real-time data to assist in controlling vehicle congestion (e.g., controlling traffic lights). As another example, host 2802 may store surveillance video uploaded by a UE. As another example, host 2802 may store or control access to media content such as video, audio, VR or AR which it can broadcast, multicast or unicast to UEs. As other examples, host 2802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2850 between host 2802 and UE 2806, in response to variations in the measurement results. The measurement procedure and/or the network functionality for reconfiguring the OTT connection may be implemented in software and hardware of host 2802 and/or UE 2806. In some embodiments, sensors (not shown) may be deployed in or in association with other devices through which OTT connection 2850 passes; the sensors may participate in the measurement procedure by supplying values of the monitored quantities exemplified above, or supplying values of other physical quantities from which software may compute or estimate the monitored quantities. The reconfiguring of OTT connection 2850 may include message format, retransmission settings, preferred routing etc.; the reconfiguring need not directly alter the operation of network node 2804. Such procedures and functionalities may be known and practiced in the art. In certain embodiments, measurements may involve proprietary UE signaling that facilitates measurements of throughput, propagation times, latency and the like, by host 2802. The measurements may be implemented in that software causes messages to be transmitted, in particular empty or ‘dummy’ messages, using OTT connection 2850 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a user equipment (UE) configured to communicate with a radio access network (RAN) node comprising a central unit (CU) and a distributed unit (DU) via a serving cell, the method comprising:
receiving, from the CU via the DU, an RRCReconfiguration message that includes channel state information (CSI) resource configurations associated with each of at least one candidate cell for L1/L2-based inter-cell mobility from the serving cell;
performing CSI measurements on the candidate cells according to the respective CSI resource configurations; and
sending, to the DU via the serving cell, one or more CSI reports based on the CSI measurements performed on the candidate cells.
   A2. The method of embodiment A1, wherein the RRCReconfiguration message also includes configurations associated with each of the at least one candidate cells.
   A2a. The method of embodiment A2, further comprising:
receiving, from the DU, a lower layer signalling message indicating that the UE should change its serving cell to a first candidate cell identified in the RRCReconfiguration message; and
performing an L1/L2 mobility procedure towards the first candidate cell and communicating in the first candidate cell according to the stored configuration associated with the first candidate cell.
   A2b. The method of embodiment A2a, wherein communicating in the first candidate cell according to the stored configuration includes one or more of the following:
monitoring a control channel of the first candidate cell in a spatial direction corresponding to a Transmission Configuration Information (TCI) state configuration included in the configuration; and
performing a contention-free or a contention-based random access (RA) procedure in the first candidate cell, according to a RA configuration included in the configuration.
   A2c. The method of any of embodiments A2-A2b, wherein one or more of the following applies:
the lower layer signaling is at a protocol layer below the radio resource control (RRC) protocol layer; and
the lower layer signaling includes one of the following: MAC Control Element (MAC CE), or PHY Downlink Control Information (DCI).
   A3. The method of any of embodiments A1-A2b, wherein the candidate cells are provided by one of more of the following: the DU, and one or more neighbor DUs.
   A3a. The method of embodiment A3, wherein the one or more neighbor DUs are associated with the CU and/or are part of the RAN node.
   A4. The method of any of embodiments A1-A3a, wherein:
the RRCReconfiguration message includes one or more reporting configurations associated with the respective CSI resource configurations; and
the CSI reports are sent based on the one or more reporting configurations.
   A5. The method of embodiment A4, wherein each reporting configuration includes one of more of the following:
configuration of physical channels used for sending CSI reports;
indication of one or more quantities or metrics to be reported; and
one or more conditions that trigger sending CSI reports.
   A6. The method of any of embodiments A1-A5, further comprising sending, to the CU via the DU, an RRCReconfiguration Complete message responsive to the RRCReconfiguration message.
   A7. The method of any of embodiments A1-A6, wherein each CSI resource configuration includes one or more of the following:
a resource configuration identifier;
identification of one or more reference signals (RS) to be transmitted by the candidate cell and measured by the UE;
an identifier of a bandwidth part in which the identified RS will be transmitted;
a type associated with the identified RS; and
an indication of the candidate cell associated with the identified RS.
   A7a. The method of embodiment A7, wherein the RRCReconfiguration message includes a plurality of CSI resource configurations arranged according to one or more of the following:
multiple sets of CSI resources associated with a single candidate cell;
multiple candidate cells associated with respective single sets of CSI resources;
multiple candidate cells associated with respective multiple sets of CSI resources.
   A7b. The method of any of embodiments A7-A7a, wherein the RS are identified by indices of beams that are transmitted in different spatial directions.
   A8. The method of any of embodiments A1-A7b, wherein one or more of the following applies:
the UE receives the RRCReconfiguration message during the UE's initial access to the serving DU; and
the RRCReconfiguration message is the initial RRCReconfiguration message received after security is activated during the UE's initial access.
   A9. The method of any of embodiments A1-A7b, wherein one or more of the following applies:
the UE receives the RRCReconfiguration message when the UE is in RRC_CONNECTED state with the RAN; and
the UE receives the RRCReconfiguration message in response to a radio resource control (RRC) Measurement Report sent by the UE.
   A10. The method of any of embodiments A1-A9, further comprising sending to the CU an indication that the UE is capable of one or more of the following: L1/L2-based inter-cell mobility, and inter-DU L1/L2 based inter-cell mobility.
   B1. A method for a central unit (CU), of a radio access network (RAN) node, that is coupled to a plurality of distributed units (DUs) of the RAN node, the method comprising:
sending, to a second DU, a request to configure a user equipment (UE) for L1/L2-based inter-cell mobility from a serving cell provided by a first DU to at least one candidate cell provided by the second DU;
receiving, from the second DU, a response including channel state information (CSI) resource configurations associated with each of at least one candidate cell L1/L2-based inter-cell mobility provided by the second DU; and
sending, to a first DU for transmission to the UE via the serving cell, an RRCReconfiguration message that includes the CSI resource configurations associated with the at least one candidate cell provided by the second DU.
   B2. The method of embodiment B1, wherein:
the response also includes configurations associated with each of the at least one candidate cells; and
the RRCReconfiguration message also includes the configurations associated with each of the at least one candidate cells.
   B3. The method of any of embodiments B1-B2, further comprising receiving, from the first DU, an RRCReconfiguration Complete transmitted by the UE in response to the RRCReconfiguration message.
   B4. The method of any of embodiments B1-B3, wherein the second DU is associated with the CU and/or is part of the RAN node.
   B4a. The method of embodiment B4, wherein:
the second DU is a neighbor DU that does not provide the UE's serving cell;
the request to configure the UE is, or is included in, a UE CONTEXT SETUP REQUEST message; and
the response is, or is included in, a UE CONTEXT SETUP RESPONSE message.
   B4b. The method of embodiment B4, wherein:
the second DU is the first DU that provides the UE's serving cell;
the request to configure the UE is, or is included in, a UE CONTEXT MODIFICATION REQUEST message; and
the response is, or is included in, a UE CONTEXT MODIFICATION RESPONSE message.
   B4c. The method of any of embodiments B4-B4b, wherein the RRCReconfiguration message is sent to the first DU in a DL RRC MESSAGE TRANSFER message.
   B5. The method of any of embodiments B1-B4c, further comprising receiving from the first DU a message comprising a radio resource control (RRC) Measurement Report sent by the UE, wherein the request to configure the UE for L1/L2-based inter-cell mobility is sent in response to the message comprising the RRC Measurement Report.
   B5a. The method of embodiment B5, wherein the RRC Measurement Report includes one or more UE measurements of the at least one candidate cell provided by the second DU.
   B5b. The method of embodiment B5a, wherein:
the at least one candidate cell includes a plurality of candidate cells;
the method further comprises selecting the plurality of candidate cells based on the UE measurements; and
the request sent to the second DU comprises respective identifiers of the plurality of candidate cells.
   B6. The method of any of embodiments B1-B5b, wherein each CSI resource configuration includes one or more of the following:
a resource configuration identifier;
identification of one or more reference signals (RS) to be transmitted by the candidate cell and measured by the UE;
an identifier of a bandwidth part in which the identified RS will be transmitted;
a type associated with the identified RS; and
an indication of the candidate cell associated with the identified RS.
   B6a. The method of embodiment B6, wherein the RRCReconfiguration message includes a plurality of CSI resource configurations arranged according to one or more of the following:
multiple sets of CSI resources associated with a single candidate cell;
multiple candidate cells associated with respective single sets of CSI resources;
multiple candidate cells associated with respective multiple sets of CSI resources.
   B7. The method of any of embodiments B1-B6a, wherein:
the RRCReconfiguration message includes one or more reporting configurations associated with the respective CSI resource configurations for the candidate cells; and
each reporting configuration includes one of more of the following:
   configuration of physical channels used for sending CSI reports;
   indication of one or more quantities or metrics to be reported; and
   one or more conditions that trigger sending CSI reports.
      B7a. The method of embodiment B7, wherein each reporting configuration identifies a physical channel to be used for sending CSI reports via the serving cell.
      B7b. The method of any of embodiments B7-B7a, further comprising receiving, from the first DU, a message comprising a configuration for a cell group comprising the UE's serving cell.
      B7c. The method of embodiment B7b, where the one or more reporting configurations are received in the message from the first DU as separated from the configuration for the cell group.
      B7c. The method of any of embodiments B7-B7a, further comprising generating the one or more reporting configurations, wherein the one or more configurations are included in the RRCReconfiguration message as separated from the configuration for the cell group.
      B8. The method of any of embodiments B1-B7c, wherein:
the method further comprises receiving from the UE an indication that the UE is capable of one or more of the following: L1/L2-based inter-cell mobility, and inter-DU L1/L2 based inter-cell mobility; and
sending the request to configure the UE is based on the indication received from the UE.
   C1. A method for a first distributed unit (DU), of a radio access network (RAN) node, that is coupled to a centralized unit (CU) of the RAN node, the method comprising:
receiving, from the CU, a request to configure a user equipment (UE) with a reporting configuration for a serving cell provided by the first DU, in association with configuring L1/L2-based inter-cell mobility for the UE; and
sending, to the CU, a response including a reporting configuration that identifies a physical channel of the serving cell to be used for sending channel state information (CSI) reports pertaining to L1/L2-based inter-cell mobility candidate cells.
   C2. The method of embodiment C1, wherein the reporting configuration also includes one of more of the following:
configuration of physical channels used for sending CSI reports;
indication of one or more quantities or metrics to be reported; and
one or more conditions that trigger sending CSI reports.
   C3. The method of any of embodiments C1-C2, wherein the response also includes CSI resource configurations associated with each of at least one candidate cell for L1/L2-based inter-cell mobility that is provided by the first DU.
   C4. The method of embodiment C3, wherein each CSI resource configuration includes one or more of the following:
a resource configuration identifier;
identification of one or more reference signals (RS) to be transmitted by the candidate cell and measured by the UE;
an identifier of a bandwidth part in which the identified RS will be transmitted;
a type associated with the identified RS; and
an indication of the candidate cell associated with the identified RS.
   C5. The method of any of embodiments C3-C4, wherein the response includes a configuration for a cell group comprising the UE's serving cell, and one of the following applies: the reporting configuration is included within the configuration for the cell group, or the reporting configuration is included in the response as separated from the configuration for the cell group.
   C6. The method of any of embodiments C1-C5, further comprising
receiving, from the CU, an RRCReconfiguration message for the UE that includes the reporting configuration and CSI resource configurations associated with at least one candidate cell for L1/L2-based inter-cell mobility; and
sending the RRCReconfiguration message to the UE via the serving cell.
   C7. The method of embodiment C6, further comprising:
receiving, from the UE, an RRCReconfigurationComplete message in response to the RRCReconfiguration message; and
sending the RRCReconfigurationComplete message to the CU.
   C8. The method of embodiment C7, wherein:
the RRCReconfiguration message is received from the CU in a DL RRC MESSAGE TRANSFER message; and
the RRCReconfigurationComplete message is sent to the CU in an UL RRC MESSAGE TRANSFER message.
   D1. A method for a second distributed unit (DU), of a radio access network (RAN) node, that is coupled to a centralized unit (CU) of the RAN node, the method comprising:
receiving, from the CU, a request to configure a user equipment (UE) for L1/L2-based inter-cell mobility from a serving cell provided by a first DU to at least one candidate cell provided by the second DU;
sending, to the CU, a response including channel state information (CSI) resource configurations associated with each of at least one candidate cell L1/L2-based inter-cell mobility provided by the second DU.
   D2. The method of embodiment D1, wherein the response also includes configurations associated with each of the at least one candidate cells.
   D3. The method of embodiment D2, further comprising performing an L1/L2 mobility procedure with the UE in a first one of the candidate cells and communicating with the UE in the first candidate cell according to the configuration associated with the first candidate cell.
   D4. The method of embodiment D3, wherein communicating with the UE in the first candidate cell according to the configuration includes one or more of the following:
transmitting a control channel of the first candidate cell in a spatial direction corresponding to a Transmission Configuration Information (TCI) state configuration included in the configuration; and
performing a contention-free or a contention-based random access (RA) procedure with the UE in the first candidate cell, according to a RA configuration included in the configuration.
   D5. The method of any of embodiments D1-D4, wherein the first DU and the second DU are associated with the CU and/or are part of the RAN node.
   D5a. The method of embodiment D5, wherein:
the second DU is a neighbor DU that does not provide the UE's serving cell;
the request to configure the UE is, or is included in, a UE CONTEXT SETUP REQUEST message; and
the response is, or is included in, a UE CONTEXT SETUP RESPONSE message.
   D5b. The method of embodiment D5, wherein:
the second DU is the first DU that provides the UE's serving cell;
the request to configure the UE is, or is included in, a UE CONTEXT MODIFICATION REQUEST message; and
the response is, or is included in, a UE CONTEXT MODIFICATION RESPONSE message.
   D6. The method of any of embodiments D1-D53b, wherein each CSI resource configuration includes one or more of the following:
a resource configuration identifier;
identification of one or more reference signals (RS) to be transmitted by the candidate cell and measured by the UE;
an identifier of a bandwidth part in which the identified RS will be transmitted;
a type associated with the identified RS; and
an indication of the candidate cell associated with the identified RS.
   D7. The method of embodiment D6, wherein the response includes a plurality of CSI resource configurations arranged according to one or more of the following:
multiple sets of CSI resources associated with a single candidate cell;
multiple candidate cells associated with respective single sets of CSI resources; multiple candidate cells associated with respective multiple sets of CSI resources.
   D8. The method of any of embodiments D1-D7, further comprising transmitting reference signals (RS) in each of the at least one candidate cells according to the respective CSI resource configurations.
   D9. The method of embodiment D8, further comprising receiving from the CU an indication that that the CSI resource configurations were applied by the UE, wherein transmitting the RS is responsive to the indication.
   E1. A user equipment (UE) configured to communicate with a radio access network (RAN) node comprising a central unit (CU) and a distributed unit (DU) via a serving cell, the UE comprising:
communication interface circuitry configured to communicate with the CU and at least the DU; and
processing circuitry operably coupled to the communication interface circuitry, wherein the processing circuitry and communication interface circuitry are further configured to perform operations corresponding to any of the methods of embodiments A1-A10.
   E2. A user equipment (UE) configured to communicate with a radio access network (RAN) node comprising a central unit (CU) and a distributed unit (DU) via a serving cell, the UE being further configured to perform operations corresponding to any of the methods of embodiments A1-A10.
   E3. A non-transitory, computer-readable medium storing computer-executable instructions that, when executed by processing circuitry of a user equipment (UE) configured to communicate with a radio access network (RAN) node comprising a central unit (CU) and a distributed unit (DU) via a serving cell, configure the UE to perform operations corresponding to any of the methods of embodiments A1-A10.
   E4. A computer program product comprising computer-executable instructions that, when executed by processing circuitry of a user equipment (UE) configured to communicate with a radio access network (RAN) node comprising a central unit (CU) and a distributed unit (DU) via a serving cell, configure the UE to perform operations corresponding to any of the methods of embodiments A1-A10.
   F1. A central unit (CU), of a radio access network (RAN) node, that is coupled to a plurality of distributed units (DUs) of the RAN node, the CU comprising:
communication interface circuitry configured to communicate with the DUs and with one or more UEs via cells provided by the DUs; and
processing circuitry operably coupled to the communication interface circuitry, whereby the processing circuitry and the communication interface circuitry are configured to perform operations corresponding to any of the methods of embodiments B1-B8.
   F2. A central unit (CU), of a radio access network (RAN) node, that is coupled to a plurality of distributed units (DUs) of the RAN node, the CU being configured to perform operations corresponding to any of the methods of embodiments B1-B8.
   F3. A non-transitory, computer-readable medium storing computer-executable instructions that, when executed by processing circuitry of a central unit (CU), of a radio access network (RAN) node, that is coupled to a plurality of distributed units (DUs) of the RAN node, configure the CU to perform operations corresponding to any of the methods of embodiments B1-B8.
   F4. A computer program product comprising computer-executable instructions that, when executed by processing circuitry of a central unit (CU), of a radio access network (RAN) node, that is coupled to a plurality of distributed units (DUs) of the RAN node, configure the CU to perform operations corresponding to any of the methods of embodiments B1-B8.
   G1. A first distributed unit (DU), of a radio access network (RAN) node, that is coupled to a centralized unit (CU) of the RAN node, the first DU comprising:
communication interface circuitry configured to communicate with the CU and with UEs via one or more cells provided by the first DU; and
processing circuitry operably coupled to the communication interface circuitry, whereby the processing circuitry and communication interface circuitry are configured to perform operations corresponding to any of the methods of embodiments C1-C8.
   G2. A first distributed unit (DU), of a radio access network (RAN) node, that is coupled to a centralized unit (CU) of the RAN node, the first DU being configured to perform operations corresponding to any of the methods of embodiments C1-C8.
   G3. A non-transitory, computer-readable medium storing computer-executable instructions that, when executed by processing circuitry of a first distributed unit (DU), of a radio access network (RAN) node, that is coupled to a centralized unit (CU) of the RAN node, configure the first DU to perform operations corresponding to any of the methods of embodiments C1-C8.
   G4. A computer program product comprising computer-executable instructions that, when executed by processing circuitry of a first distributed unit (DU), of a radio access network (RAN) node, that is coupled to a centralized unit (CU) of the RAN node, configure the first DU to perform operations corresponding to any of the methods of embodiments C1-C8.
   H1. A second distributed unit (DU), of a radio access network (RAN) node, that is coupled to a centralized unit (CU) of the RAN node, the second DU comprising:
communication interface circuitry configured to communicate with the CU and with UEs via one or more cells provided by the second DU; and
processing circuitry operably coupled to the communication interface circuitry, whereby the processing circuitry and communication interface circuitry are configured to perform operations corresponding to any of the methods of embodiments D1-D9.
   H2. A second distributed unit (DU), of a radio access network (RAN) node, that is coupled to a centralized unit (CU) of the RAN node, the second DU being configured to perform operations corresponding to any of the methods of embodiments D1-D9.
   H3. A non-transitory, computer-readable medium storing computer-executable instructions that, when executed by processing circuitry of a second distributed unit (DU), of a radio access network (RAN) node, that is coupled to a centralized unit (CU) of the RAN node, configure the second DU to perform operations corresponding to any of the methods of embodiments D1-D9.
   H4. A computer program product comprising computer-executable instructions that, when executed by processing circuitry of a second distributed unit (DU), of a radio access network (RAN) node, that is coupled to a centralized unit (CU) of the RAN node, configure the second DU to perform operations corresponding to any of the methods of embodiments D1-D9.

1. A method for a user equipment, UE, configured to communicate with a radio access network, RAN, node comprising a central unit, CU, and a distributed unit, DU, via a serving cell, the method comprising:
receiving, from the CU via the DU, an RRCReconfiguration message that includes channel state information (CSI) resource configurations associated with at least one candidate cell for L1/L2-based inter-cell mobility and one or more reporting configurations associated with the respective CSI resource configurations, wherein the at least one candidate cell is provided by one or more neighbor DUs;
performing CSI measurements on the at least one candidate cell according to the respective CSI resource configurations; and
sending, to the DU via the serving cell, one or more CSI reports based on the one or more reporting configurations and the CSI measurements performed on the at least one candidate cell.

2. The method of claim 1, wherein:
the RRCReconfiguration message also includes respective configurations associated with the at least one candidate cell; and
the method further comprises:
receiving, from the DU, a lower layer signalling message indicating that the UE should change its serving cell to a first candidate cell identified in the RRCReconfiguration message; and
performing an L1/L2 mobility procedure towards the first candidate cell and communicating in the first candidate cell according to the configuration associated with the first candidate cell.

3. The method of claim 2, wherein communicating in the first candidate cell according to the stored configuration includes one or more of the following:
monitoring a control channel of the first candidate cell in a spatial direction corresponding to a Transmission Configuration Information, TCI, state configuration included in the configuration; and
performing a contention-free or a contention-based random access, RA, procedure in the first candidate cell, according to a RA configuration included in the configuration.

4.-6. (canceled)

7. The method of claim 1, wherein each reporting configuration includes one of more of the following:
configuration of physical channels used for sending CSI reports;
indication of one or more quantities or metrics to be reported; and
one or more conditions that trigger sending CSI reports.

8. (canceled)

9. The method of claim 1, wherein
each CSI resource configuration includes one or more of the following:
a resource configuration identifier;
identification of one or more reference signals, RS, to be transmitted by the candidate cell and measured by the UE;
an identifier of a bandwidth part in which the identified RS will be transmitted;
a type associated with the identified RS; and
an indication of the candidate cell associated with the identified RS.

10. The method of claim 9, wherein the RRCReconfiguration message includes a plurality of CSI resource configurations arranged according to one or more of the following:
multiple sets of CSI resources associated with a single candidate cell;
multiple candidate cells associated with respective single sets of CSI resources; and
multiple candidate cells associated with respective multiple sets of CSI resources.

11. (canceled)

12. The method of claim 1,
wherein:
a first set of conditions or a second set of conditions applies to the RRCReconfiguration message;
the first set of conditions includes one or more of the following:
the RRCReconfiguration message is received during the UE's initial access to the serving DU, and
the RRCReconfiguration message is an initial RRCReconfiguration message received after security is activated during the UE's initial access; and
the second set of conditions includes one or more of the following:
the RRCReconfiguration message is received when the UE is in RRC_CONNECTED state with the RAN, and
the RRCReconfiguration message is received in response to a radio resource control, RRC, Measurement Report sent by the UE.

13. The method of claim 1, further comprising sending to the CU an indication that the UE is capable of one or more of the following: L1/L2-based inter-cell mobility, and inter-DU L1/L2 based inter-cell mobility.

14. A method for a central unit, CU, of a radio access network, RAN, node, the method comprising:
sending, to a second distributed unit, DU, of the RAN node, a request to configure a user equipment, UE, for L1/L2-based inter-cell mobility from a serving cell provided by a first DU of the RAN node to at least one candidate cell provided by the second DU;
receiving, from the second DU, a response including channel state information, CSI, resource configurations associated with the at least one candidate cell provided by the second DU; and
sending, to the first DU for transmission to the UE via the serving cell, an RRCReconfiguration message that includes the CSI resource configurations associated with the at least one candidate cell provided by the second DU and one or more reporting configurations associated with the respective CSI resource configurations.

15. The method of claim 14, wherein:
the response also includes respective configurations associated with the at least one candidate cell; and
the RRCReconfiguration message also includes the respective configurations associated with the at least one candidate cell.

16. The method of claim 14, wherein:
the second DU is a neighbor DU that does not provide the UE's serving cell;
the request to configure the UE is, or is included in, a UE CONTEXT SETUP REQUEST message; and
the response is, or is included in, a UE CONTEXT SETUP RESPONSE message.

17. (canceled)

18. The method of claim 14, further comprising receiving from the first DU a message including a radio resource control, RRC, Measurement Report sent by the UE, wherein the request to configure the UE for L1/L2-based inter-cell mobility is sent in response to the message including the RRC Measurement Report.

19. (canceled)

20. The method of claim 14, wherein:
the at least one candidate cell includes a plurality of candidate cells;
the method further comprises selecting the plurality of candidate cells based on the UE measurements; and
the request sent to the second DU comprises respective identifiers of the plurality of candidate cells.

21. The method of claim 14, wherein each CSI resource configuration includes one or more of the following:
a resource configuration identifier;
identification of one or more reference signals, RS, to be transmitted by the candidate cell and measured by the UE;
an identifier of a bandwidth part in which the identified RS will be transmitted;
a type associated with the identified RS; and
an indication of the candidate cell associated with the identified RS.

22. The method of claim 21, wherein the RRCReconfiguration message includes a plurality of CSI resource configurations arranged according to one or more of the following:
multiple sets of CSI resources associated with a single candidate cell;
multiple candidate cells associated with respective single sets of CSI resources; and
multiple candidate cells associated with respective multiple sets of CSI resources.

23. The method of any of claim 14, wherein:
each reporting configuration includes one of more of the following:
configuration of physical channels used for sending CSI reports;
indication of one or more quantities or metrics to be reported; and
one or more conditions that trigger sending CSI reports.

24. The method of claim 23, further comprising receiving, from the first DU, a message including a configuration for a cell group comprising the UE's serving cell, wherein the one or more reporting configurations are received in the message as separated from the configuration for the cell group.

25. The method of claim 23, further comprising generating the one or more reporting configurations, wherein the one or more reporting configurations are included in the RRCReconfiguration message as separated from a configuration for a cell group comprising the UE's serving cell.

26. The method of claim 14, wherein:
the method further comprises receiving from the UE an indication that the UE is capable of one or more of the following: L1/L2-based inter-cell mobility, and inter-DU L1/L2 based inter-cell mobility; and
sending the request to configure the UE is based on the indication received from the UE.

27.-41. (canceled)

42. A user equipment, UE configured to communicate with a radio access network, RAN, node comprising a central unit, CU (110, 720) and a distributed unit, DU via a serving cell, the UE comprising:
communication interface circuitry (2412) configured to communicate with the CU and at least the DU; and
processing circuitry operably coupled to the communication interface circuitry, wherein the processing circuitry and communication interface circuitry are further configured to:
receive, from the CU via the DU, an RRCReconfiguration message that includes channel state information, CSI, resource configurations associated with at least one candidate cell for L1/L2-based inter-cell mobility and one or more reporting configurations associated with the respective CSI resource configurations, wherein the at least one candidate cell is provided by one or more neighbor DUs;
perform CSI measurements on the at least one candidate cell according to the respective CSI resource configurations; and
send, to the DU via the serving cell, one or more CSI reports based on the CSI measurements performed on the at least one candidate cell and the one or more reporting configurations.

43.-47. (canceled)

48. A central unit, CU of a radio access network, RAN, node, the CU comprising:
communication interface circuitry configured to communicate with a plurality of distributed units, DUs of the RAN node and with one or more user equipment, UEs via cells provided by the DUs; and
processing circuitry operably coupled to the communication interface circuitry, whereby the processing circuitry and the communication interface circuitry are configured to:
send, to a second DU of the RAN node, a request to configure a UE for L1/L2-based inter-cell mobility from a serving cell provided by a first DU of the RAN node to at least one candidate cell provided by the second DU;
receive, from the second DU, a response including channel state information, CSI, resource configurations associated with the at least one candidate cell provided by the second DU; and
send, to the first DU for transmission to the UE via the serving cell, an RRCReconfiguration message that includes the CSI resource configurations associated with the at least one candidate cell provided by the second DU and one or more reporting configurations associated with the respective CSI resource configurations.

49.-65. (canceled)
